(19) United States
(12) Patent Application Publication
(10) Pub. No.: US 2017/0181215 A1
(43) Pub. Date: Jun. 22, 2017

(54) METHODS AND DEVICES FOR MANAGING MESSAGES DELAYED FOLLOWING A LOSS OF NETWORK CONNECTIVITY

(71) Applicant: QUALCOMM Incorporated, San Diego, CA (US)

(72) Inventors: Neeraj Gaur, San Marcos, CA (US); Ajith Payyappilly, San Diego, CA (US); Aditya Namjoshi, San Diego, CA (US); Ashish Agarwal, San Diego, CA (US); Liping Shen, San Diego, CA (US); Juan Zhang, San Diego, CA (US)

(21) Appl. No.: 14/971,148

(22) Filed: Dec. 16, 2015

(51) Int. Cl. H04W 76/02; H04L 29/06

(52) U.S. Cl. CPC H04W 76/028; H04L 65/1006; H04L 65/1016

(57) ABSTRACT

Methods and devices for wireless communication are disclosed. For example, one method includes detecting a loss of connectivity between a user equipment and a network, the user equipment having at least a first and second layer of a communication protocol. The method further includes sending messages from the first layer to the second layer, at least one message of the messages being delayed at the second layer based on the loss of connectivity. The method also includes identifying, at the first layer, at least one trigger condition, determining, at the first layer, to abort the sending of a first delayed message to the network based on the identified at least one trigger condition, communicating, by the first layer, to the second layer the determination to abort the first delayed message; and aborting the sending of the first delayed message at the second layer.

### BACKGROUND

Field

The present application relates generally to wireless communication devices, and more particularly, to wireless communication between a network and a user equipment having a communication protocol stack utilized to determine whether to abort or send messages delayed as a result of a loss in network connectivity.

Background

Communication networks are used to carry a wide variety of data and provide a number of real-time communications services, for example Voice over IP (VoIP), Telephony, Rich Communication Services (RCS), etc. To support real-time communications, communications applications need to establish and manage connections (also referred to as sessions or dialogs) between communication devices. A session is a set of interactions between computing devices that occurs over a period of time. As an example, real-time communications applications such as MESSENGER or VoIP establish sessions between communicating devices on behalf of users. Applications may use various mechanisms to establish sessions.

An example of such a mechanism is a “Session Initiation Protocol” (SIP). SIP is an application-level control protocol that computing devices can use to discover one another and to establish, modify, and terminate sessions between computing devices. Communication applications may employ SIP with a lower-level protocol to establish sessions through an exchange of messages or data packets over the communication network. SIP may use lower-level connections to transport a session message, such as Transmission Control Protocol/Internet Protocol (“TCP/IP”), which are commonly employed layered communication protocols. Other typical lower-level connections with data services layers and radio layers. The application, transport, data services and radio layers, together with other layers, are jointly referred to as a communication protocol stack. Typical communication devices (e.g., smartphones and tablets) employ multiple processors, where one or more of the layers of the communication protocol stack reside on different processors. Messages from the application layer following SIP are transmitted through the various layers of the TCP/IP communication protocol stack and radio layers before the message is transmitted to the communications network.

In typical implementations of layered communication protocol stacks utilized in communication devices, the various layers of the software work independently through a specific and associated protocol standard for each layer. Accordingly, each layer makes determinations on what to do with each message independent of information from other layers or the communication network, based on the protocol a given layer is set to follow. In certain scenarios, a high level layer sends a SIP message to the lower layers for transmission to the communications network. However, due to a loss in connectivity between the communications network and the communication device, the SIP message is delayed at the lower layer where it is queued for transmission when connectivity is re-established. Once connectivity is re-established, it may be un-desirable or desirable to send the delayed SIP message. The separation of the layers in the communication protocol stack results in the lower layers determining to send the delayed packets according to the protocol associated with the lower layer without instruction from the higher level layers.

### SUMMARY

Various implementations of methods and apparatus within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims.

One aspect of the present disclosure provides a method for wireless communications. The method includes detecting, at a user equipment, a loss of connectivity between the user equipment and a communication network, the user equipment having at least a first and second layer of a communication protocol and sending one or more messages from the first layer to the second layer, the second layer configured to send the one or more messages to the communication network, at least one message of the one or more messages being delayed at the second layer based on the loss of connectivity. In some embodiments, the first layer is an IP multimedia subsystems (IMS) layer and the one or more messages may be based on SIP. In some embodiments, the user equipment may include multiple processors, the first layer located on a first processor and the second layer located on a second processor. The method also includes identifying, at the first layer, at least one trigger condition and determining, at the first layer, to abort the sending of a first delayed message of the at least one delayed message to the communication network based on the identified at least one trigger condition. The method further includes communicating, by the first layer, to the second layer the determination to abort the sending of the first delayed message and aborting the sending of the first delayed message at the second layer. In some embodiments, the method may also include determining, at the first layer, one or more of the at least one delayed message to be sent from the second layer to the communication network when connectivity between the user equipment and communication network is re-established.

In some implementations, the loss of connectivity is based on an access barring procedure, the access barring procedure configured to block the user equipment from sending messages to the communication network. In one embodiment, the method may include identifying at least one trigger condition includes the first layer sending the one or more messages during the access barring procedure, wherein each of the one or more messages is indicative of an attempt to register the user equipment on the communication network. In another embodiment, the method may include identifying at least one trigger condition includes, at the second layer of the of the communication protocol, receiving a cancel request message and detecting the at least one delayed message, the at least one delayed message indicative of an invite request message, wherein the invite request message is indicative of the user equipment initiating a voice call and the cancel request message is indicative that the invite request message was blocked by the access barring procedure. In yet another embodiment, the method may include identifying at least one trigger condition includes the first layer receiving a rejection notification based on the user equipment attempting to make a call during the access barring procedure while the at least one delayed message is delayed, the at least one delayed message being at least one pending TCP sync request message.

In some implementations, the step of aborting the sending of the first delayed message at the second layer includes identifying the first delayed message by the second layer based on the determination communicated from the first layer, and deleting the first delayed message by the second layer.

Another aspect of the present disclosure provides a device for wireless communications. The device includes one or more processors. In some embodiments, the device may include multiple processors, the first layer located on a first processor and the second layer located on a second processor. The one or more processors are configured to detect a loss of connectivity between the device and a communication network, the device having at least a first and second layer of a communication protocol, and send one or more messages from the first layer to the second layer, the second layer configured to send the one or more messages to communication network, at least one message of the one or more messages being delayed at the second layer based on the loss of connectivity. In some embodiments, the first layer may be an IMS layer and the one or more messages may be based on SIP. The processors are further configured to identify, at the first layer, at least one trigger condition, and determine, at the first layer, to abort the sending of a first delayed message of the at least delayed message to the communication network based on the identified at least one trigger condition. The processors are further configured to communicate, by the first layer, to the second layer the determination to abort the sending of first delayed message; and abort the sending of the first delayed message at the second layer. In some embodiments, the one or more processors may also be configured to determine, at the first layer, one or more of the at least one delayed message to be sent from the second layer to the communication network when connectivity between the device and communication network is re-established.

In some implementations, the loss of connectivity is based on an access barring procedure, the access barring procedure configured to block the device from sending messages to the communication network. In one embodiment, the at least one trigger condition includes the first layer sending the one or more messages during the access barring procedure, wherein each of the one or more messages is indicative of an attempt to register the device on the communication network. In another embodiment, the at least one trigger condition includes, at the second layer of the of the communication protocol, receiving a cancel request message and detecting the at least one delayed message, the at least one delayed message indicative of an invite request message, wherein the invite request message is indicative of the device initiating a voice call and the cancel request message is indicative that the invite request message was blocked by the access barring procedure. In yet another embodiment, the at least one trigger condition includes the first layer receiving a rejection notification based on the device attempting to make a call during the access barring procedure while the at least one delayed message is delayed, the at least one delayed message being at least one pending TCP sync request message.

In some implementations, the one or more processors may be further configured to identify the first delayed message by the second layer based on the determination communicated from the first layer, and delete the first delayed message by the second layer.

Another aspect of the present disclosure provides a device for wireless communications. The device includes means for detecting a loss of connectivity between the device and a communication network, the device having at least a first and second layer of a communication protocol, and means for sending one or more messages from the first layer to the second layer, the second layer configured to send the one or more messages to communication network, at least one message of the one or more messages being delayed at the second layer based on the loss of connectivity. In some embodiments, the first layer may be an IMS layer and the one or more messages may be based on SIP. The device also includes means for identifying, at the first layer, at least one trigger condition, and means for determining, at the first layer, to abort the sending of a first delayed message of the at least one delayed message to the communication network based on the identified at least one trigger condition. The device also includes means for communicating, by the first layer, to the second layer the determination to abort the sending of the first delayed message, and means for aborting the sending of the first delayed message at the second layer. In some embodiments, the means for aborting the sending of the first delayed message at the second layer includes means for identifying the first delayed message by the second layer based on the communication received from the first layer, and means for deleting the first delayed message by the second layer.

Another aspect of the present disclosure provides a non-transitory computer readable medium comprising code that, when executed, performs a method for providing wireless communications. The method includes detecting, at a user equipment, a loss of connectivity between the user equipment and a communication network, the user equipment having at least a first and second layer of a communication protocol, and sending one or more messages from the first layer to the second layer, the second layer configured to send the one or more messages to communication network, at least one message of the one or more messages being delayed at the second layer based on the loss of connectivity. In some embodiments, the first layer may be an IMS layer and the one or more messages may be based on SIP. The method also include identifying, at the first layer, at least one trigger condition, and determining, at the first layer, to abort the sending of a first delayed message of the at least one delayed message to the communication network based on the identified at least one trigger condition. The method further includes communicating, by the first layer, to the second layer the determination to abort the sending of the first delayed message, and aborting the sending of the first delayed message at the second layer.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 is a block diagram of an exemplary wireless communications system utilizing a layered communication protocol stack for wireless communication

FIG. 2 illustrates an example message flow for establishing a registration session between a communication device and a wireless communications network.

FIG. 3 illustrates an example message flow of a radio-level failure.

FIG. 4 illustrates an example message flow of an IP connectivity failure.

FIG. 5 illustrates an example message flow for aborting delayed messages due to a radio-level loss in connectivity.

FIG. 6 illustrates an example message flow for aborting delayed messages due to an IP connectivity failure.

FIG. 7A illustrates an example of various components that may be utilized in a wireless communication device that may be employed within a wireless communication network.

FIG. 7B illustrates a functional block diagram illustrating an application processor and cellular modem that may be utilized in the wireless communication device of FIG. 7A.

FIG. 8 is a flow chart of an aspect of an exemplary method of wireless communication.

FIG. 9A illustrates an example message flow of communication device registration messages transmitted during a loss in connectivity indicative of a trigger condition.

FIG. 9B illustrates another example message flow of an implementation of the trigger condition of FIG. 9A in accordance with the methods and deceives described herein.

FIG. 10A illustrates an example message flow of multiple data transfer request messages transmitted during a temporary loss in connectivity indicative of another trigger condition.

FIG. 10B illustrates another example message flow of an implementation of the trigger condition of FIG. 10A in accordance with the methods and deceives described herein.

FIG. 11A illustrates an example message flow of multiple connection messages transmitted during a temporary loss in connectivity indicative of another trigger condition.

FIG. 11B illustrates another example message flow of an implementation of the trigger condition of FIG. 11A in accordance with the methods and deceives described herein.

FIG. 12 is a functional block diagram of an exemplary wireless communication device that may be employed within the wireless communication system.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The word “exemplary” is used herein to mean “serving as an example, instance, or illustration.” Any implementation described herein as “exemplary’ is not necessarily to be construed as preferred or advantageous over other implementations. The following description is presented to enable any person skilled in the art to make and use the invention. Details are set forth in the following description for purpose of explanation. It should be appreciated that one of ordinary skill in the art would realize that the invention may be practiced without the use of these specific details. In other instances, well known structures and processes are not elaborated in order not to obscure the description of the invention with unnecessary details. Thus, the present invention is not intended to be limited by the implementations shown, but is to be accorded with the widest scope consistent with the principles and features disclosed herein.

As used herein, the term “message” generally refers to a data stream formed into segments that can be carried by the communication protocol employed in the communication device. These segments of data are commonly referred to as “packets,” “frames,” and “messages.” Each message generally comprises a header and payload. The header comprises data necessary for routing and interpreting the message. The payload comprises the actual data that is being sent or received. As used herein, the term “messages” may also be referred to as “data packets,” “information,” “data frame,” “frame,” “commands,” and “instructions.” In some implementations, messages may be exchanged between various layers of a layered communication protocol of a communication device. In some implementations, information may be exchanged between various components of a communication network. In some implementations, information may be exchanged between one or more layers of the communication device and one or more components of the communication network. In some embodiments, the term “message” or “messages” may refer to a message utilizing SIP as an application-level control protocol used by communication devices to discover one another and to establish, modify, and terminate sessions between computing devices. SIP is a proposed Internet standard and the SIP specification may be referred to as “RFC 3261.” In some embodiments, messaging protocols may be specific to a single layer of the communication protocol stack. For example, messages utilizing SIP are specific to the IP multimedia subsystems (IMS) layer of the communication protocol stack.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3GPP2). These various radio technologies and standards are known in the art.

It should be emphasized that the disclosed techniques may also be applicable to technologies and the associated standards related to LTE Advanced, LTE, W-CDMA, TDMA, OFDMA, High Rate Packet Data (HRPD), Evolved High Rate Packet Data (eHRPD), Worldwide Interoperability for Microwave Access (WiMax), GSM, enhanced data rate for GSM evolution (EDGE), and so forth. Terminologies associated with different technologies can vary. For example, depending on the technology considered, the User Equipment (UE) used in UMTS can sometimes be called a mobile station, a user terminal, a subscriber unit, an access terminal, etc., to name just a few. Likewise, Node B used in UMTS can sometimes be called an evolved Node B (eNodeB), an access node, an access point (AP), a base station (BS), HRPD base station, and so forth. It should be noted here that different terminologies apply to different technologies when applicable.

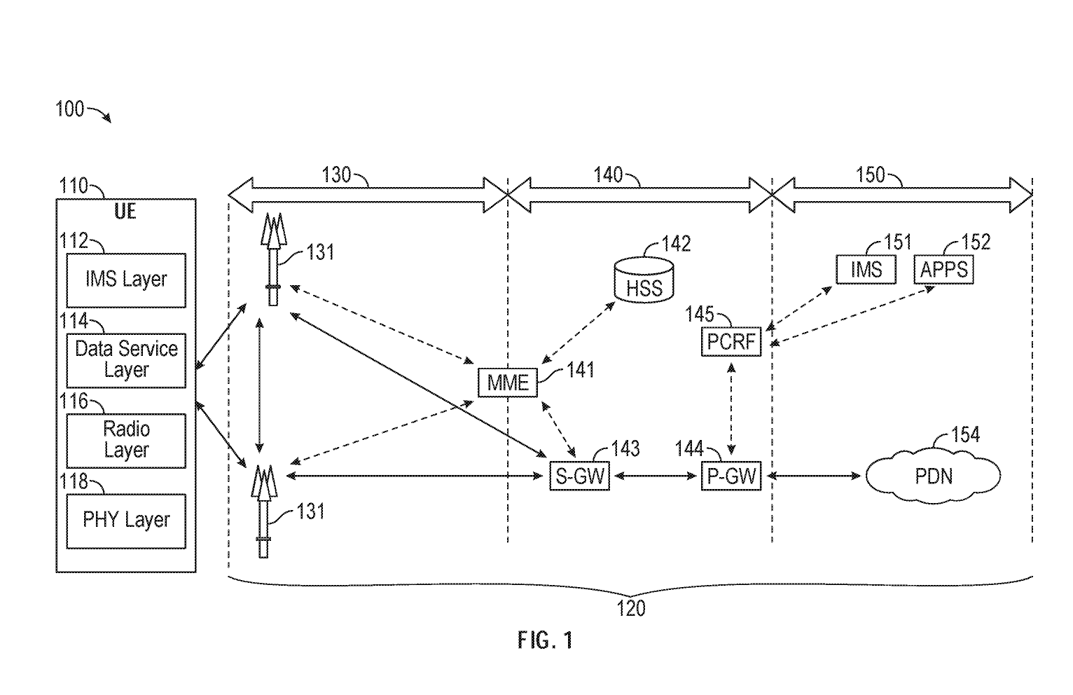

Turning to FIG. 1, a block diagram is depicted of an exemplary wireless communications system 100 utilizing a layered communication protocol stack for wireless communication. The system 100 includes a UE 110 having a layered communication protocol stack. The system 100 also includes a wireless communications network 120 which includes radio access network (RAN) 130, a data core network 140, and an application network 150. The UE 110 is configured to access the network 120 by establishing a connection with the data core network 140 through the RAN 130 to communicate with other devices and applications on the application network 150.

The RAN 130 includes multiple access points (AP), for example, APs 131. Each AP 131 can be a Wi-Fi access point, a cellular access point, an LTE or other 3G access point, a radio access point, a wired access point (e.g., Ethernet), or other network portal. Accordingly, the network 120 can be a packet switched network, a public network, a wide-area network, a private area network, a mesh network, a cellular network, a radio network, a local area network, or other such communication network configured to transmit and receive data between devices.

The AP 131 is configured to permit certain UEs access to the network 120. The AP 131 performs authorization for the UE 110 before allowing access to the network 120. The UE 110 provides information to the AP 131 which can be used to determine whether or not to allow the UE 110 to access the network 120 based on subscriber information associated with UE 110. The AP 131 can be generally associated with a particular service provider. The service provider is the entity which determines who can access the network 120. For example, a telecommunications company can construct a radio tower access point to allow customers with a valid subscription to access a network. In such cases, the telecommunications company may wish to limit or otherwise control who can access the network.

The data core network 140 includes, at least, a mobility management entity (MME) 141, a home subscriber server (HSS) 142, a serving gateway (S-GW) 143, a packet data network (PDN) gateway (P-GW) 144, and a policy and charging rules function (PCRF) 145. The UE 110 accesses the data core network 140 through the AP 131. In one embodiment, the AP 131 forwards messages to the MME 141. The MME 141 is configured to manage signaling for mobility between various networks, such as but not limited to, data packet-based networks (e.g., LTE or 3G networks) or circuit-switched networks. The MME 141 may also be configured to manage tracking area lists and P-GW 144 and S-GW 143 selection. The MME 141 may also manage authentication of the UE 110 on the network 120. The MME 141 may be configured to communicate with the HSS 142 and the S-GW 143.

The HSS 142 may be configured to store user data related to each UE on the network 120. The data stored at the HSS 142 may include roaming restrictions lists, names of accessible access points, an address of a current serving MME, and authentication parameters with security keys for each UE. The HSS 142 may also be configured to update and monitor current tracking areas of the UE. The HSS 142 may be configured to respond and communicate the one or more MME 141 located on the network 120.

The S-GW 143 may be configured as a local mobility anchor for access point handover procedures between different networks and/or access points on the same network. In this way, the S-GW 143 may be configured to facilitate mobility of UE 110 throughout the network 120. The S-GW 143 may also be configured to manage message buffering and initiation of network triggered service requests. The S-GW 143 may also facilitate message routing and forwarding along the uplink and downlink of the P-GW 144 and the AP 131 to the UE 110.

The P-GW 144 is configured to interface with the PDN 154 on the application network 150 and the S-GW 143. In one embodiment, the P-GW 144 is configured to perform message filtering for each UE. The P-GW 144 is thus configured to direct messages to the appropriate UE on the network 120 and forwards the messages to the S-GW 143. In one embodiment, the P-GW 144 may utilize UE IP addresses to identify and allocate the appropriate message to a particular UE 110 and then transmit the message on the downlink to UE 110. The P-GW 144 is configured to interface with the PDN 154 to facilitate these functions.

The PCRF 145 is configured to interface with the application network 150 and P-GW 144. For example, the application network 150 may include a proxy-call session control function (P-CSCF) or other policy enabled applications, and the PCRF 145 interfaces with the application network 150 to convey the policy decisions from the application network 150 to the P-GW 144. In one embodiment, the PCRF 145 determines how services are treated at the P-GW 144 in accordance with a user's subscription policy.

The application network 150 includes, at least, an IMS 151, applications 152, and PDN 154. In one embodiment applications 152 may be a P-CSCF or another policy enabled application. PDN 154 represents the data packet-based network that communication devices access to exchange messages in network 120. In one embodiment, IMS 151 utilizes IMS technologies to provide real-time services such as voice over IP (VoIP), video telephony, rich communication services (RCS), etc., to the UE 110 over network 120. Certain implementations of IMS technologies use session initiation protocol (SIP) signaling as the signaling protocol between the UE 110 and the network 120.

The UE 110 is configured to access a network 120 via AP 131 by utilizing a layered communication protocol stack. The UE 110 may be an electronic communication device such as a mobile phone, a smart phone, a tablet computer, a personal computer, a game console, a set-top box, or other communication device configured to transmit/receive data. In some embodiments, the UE 110 may contain subscriber identify information that facilitates authentication of the UE 110 on the network 120. The UE 110 may support communication services and include a variety of applications to carry out the functions of the UE 110. The UE 110 may be configured to monitor radio connectivity and convey this information to the RAN 130. The UE 110 may be configured to support data packet-based networks and circuit-switched networks.

The UE 110 includes a communication protocol stack. Communication networks frequently rely on layered communication protocols to simplify network designs. Protocol layering entails dividing the network design into functional layers and assigning protocols to each layer to perform and execute the functions of an assigned layer. The layers represent levels of abstraction for performing functions such as data handling, connection, and session management. Within each layer, one or more physical entities implement its functionality.

For example, the functions of data delivery and connection management may be put into separate layers, and therefore separate protocols. Thus, one protocol is designed to perform data delivery, and another protocol performs session management. The protocol for session management is “layered” above the protocol handling data delivery. The message delivery protocol has no knowledge of session management. Similarly, the session management protocol is not concerned with message delivery. One non-limiting advantage of abstraction through layering enables simplification of the various individual layers and protocols. The protocols can then be assembled into a useful whole. Protocol layering thus produces simple protocols, each with a few well-defined tasks. Individual protocols can also be removed, modified, or replaced as needed for particular applications.

Implementation of a given functional layer may occur within a single element or be distributed across multiple elements. Generally, however, the layering corresponds to a hardware or software hierarchy of elements. Typically, each layer interacts directly only with the layer immediately beneath it, and provides facilities for use by the layer above it. The protocols enable an entity in one host to interact with a corresponding entity at the same layer in a remote host. In the embodiment of FIG. 1, the communication protocol stack includes at least an IMS layer 112, a data services layer 114, and a radio layer 116. The functions and processes of the various layers of UE 110 will be described in detail below.

The layered communication protocol stack of the UE 110 is configured to specify how data should be packetized, addressed, transmitted, routed, and received between the network 120 and UE 110. The functionality of the communication protocol stack is organized into multiple layers used to sort related signaling protocols. The layers may be referred to as a first layer, second layer, etc. of the communication protocol stack. In other embodiments, the layers may be referred to as an upper layer and one or more lower layers. In some embodiments, the layered communication protocol stack of UE 110 includes, from an upper layer to a lower layer, at least an IMS layer 112, a data services layer 114, and a radio layer 116. The IMS layer 112 may be included in a broader application layer (not shown). For example, in some embodiments, the IMS layer 112 may reside at the application layer on top of a high level operating system (HLOS), for example, Android, Windows, etc. In some embodiments, the radio layer may be, for example, a network layer, an LTE radio layer, a UMTS radio layer, or any radio layer for connecting to an access point in the network.

Certain implementations of application layers including IMS layer 112 may be used in the context of wireless communication technologies and, more specifically, IMS technologies. IMS technologies facilitate, through communication with IMS 151, real-time services such as VoIP, video telephony, RCS, etc. Certain implementations of IMS layer 112 use SIP signaling as the messaging protocol to establish a session through an exchange of SIP messages between components of UE 110, AP 131, and IMS 151 of network 120. The messages sent by the IMS layer 112 traverse the various layers of the communication protocol stack before transmitted to the AP 131. In certain embodiments, UEs utilize multiple processors and the various layers may be located on different processors. Such processors may be from the same or different vendors.

In some embodiments, applications installed on UE 110 utilize the application layer to create user data and communicate this data to other applications on another or the same UE. The applications, or processes, make use of the services provided by the underlying, lower layers, for example, a transport layer, data services layer and radio layer which provide reliable or unreliable pipes to other processes. In some embodiment, the application layer is the layer in which higher level protocols operate. Examples of application layer protocols include SIP, Simple Mail Transfer Protocol (SMTP), File Transfer Protocol (FTP), SSH, Hypertext Transfer Protocol (HTTP), and the Dynamic Host Configuration Protocol (DHCP) operate. In some implementations, the application layer includes the protocols used by applications for providing user services or exchanging application data over the network connections established by the lower level protocols, but this may include some basic network support services, such as many routing protocols, and host configuration protocols. Data coded according to application layer protocols are encapsulated into transport layer protocol units, such as TCP or User Datagram Protocol messages, which in turn use lower layer protocols to effect actual data transfer over a radio connection to the network 120. In typical implementations, the application layer protocols generally treat lower layer protocols as black boxes which provide a stable network connection across which to communicate. The application layer protocols may be unaware of key qualities of the lower layer connection such as the end point IP addresses and port numbers.

Some embodiments of UE 110 having a layered communication protocol stack may include a transport layer (not shown). The transport layer may be configured to perform UE-to-UE communications on either the same or different UEs and on either the local network or remote networks separated by routers. It provides a channel for the communication needs of applications. UDP is the basic transport layer protocol, providing an unreliable datagram service. In one embodiment, the transport layer uses Transmission Control Protocol/Internet Protocol (TCP) to provide flow-control, connection establishment, and reliable transmission of data. TCP is a connection-oriented, reliable-delivery transport-layer protocol. TCP typically provides an interface between an application layer and one or more lower layers. The application layer generally communicates with a transport layer using TCP by sending or receiving a message. TCP organizes this message into segments that can be carried by the protocol employed at the lower layers, e.g., a lower layer using Internet Protocol (IP).

The transport layer may be configured to establish basic data channels that applications use for task-specific data exchange. The layer establishes process-to-process connectivity, such as end-to-end services that are independent of the structure of user data and the logistics of exchanging information for any particular specific purpose. Its responsibility includes end-to-end message transfer independent of the underlying network, along with error control, segmentation, flow control, congestion control, and application addressing (port numbers).

The data services layer 114 is configured to exchange messages across network boundaries. It provides a uniform networking interface. Data services layer 114 may be configured to define the addressing and routing structures used for the layered communication protocol stack. In one embodiment, the protocol in the data services layer 114 is the Internet Protocol, which defines IP addresses, which may be configured to transport messages to the next IP router that has the connectivity to a network closer to the final data destination. In some embodiments, the data services layer 114 may be configured to send messages across potentially multiple networks.

In some implementations, the data services layer 114 may be unaware of the data structures at the transport layer. In such implementations, the data services layer 114 also may be unable to distinguish between operations of the various upper layer protocols.

The radio layer 116 is configured to define the networking methods within the scope of the local radio link on which the UE 110 communicates to network 120 through AP 131. This layer includes protocols used to describe the local network topology and the interfaces needed to effect transmission of messages from data services layer 114. Radio layer 116 is configured to move messages between the data services layer 114 interfaces of two different communication devices on the same link (e.g., radio layer 116 and AP 131). The processes of transmitting and receiving messages on a given link can be controlled both in the software device driver for the network card, as well as on firmware or specialized chipsets. These perform data link functions such as adding a packet header to prepare the message for transmission, and transmit the message over a physical layer 118.

In some embodiments, UE 110 may include a physical layer 118 configured to transmit the raw bits representing the messages rather than the logical messages over a physical link connecting the UE 110 to the AP 131. The physical layer 118 may include basic networking hardware transmission technologies of the wireless network. The physical layer 118 may be a means to facilitate the transmission of a message from the UE 110 to the network 120 via AP 131.

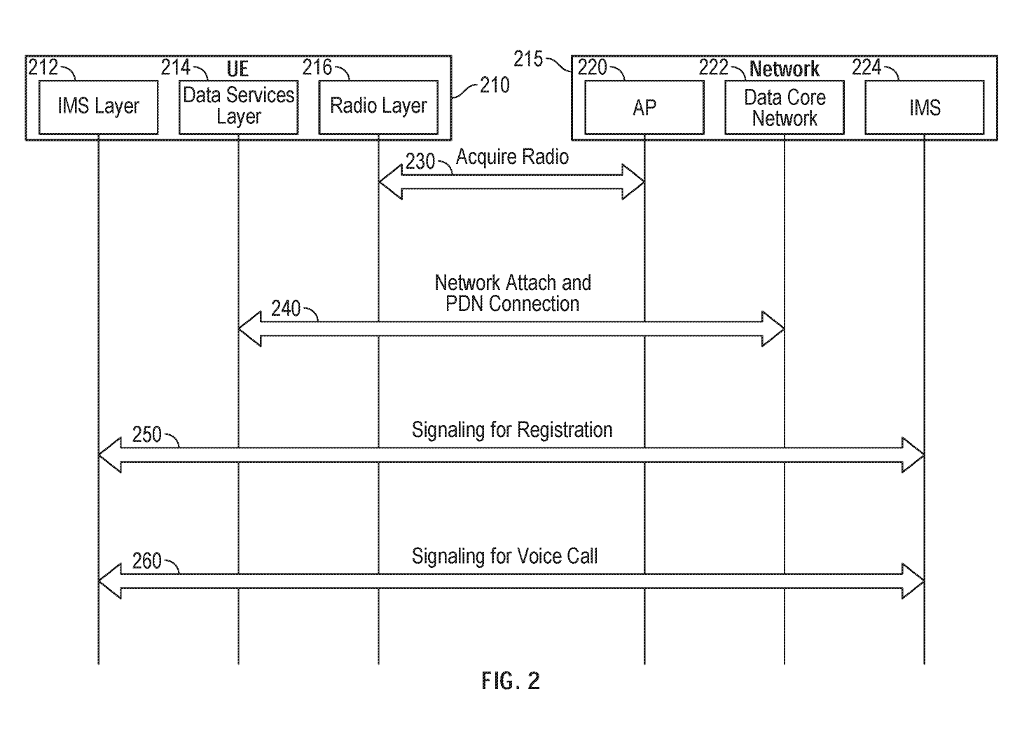

FIG. 2 illustrates an example message flow for establishing a registration session between a UE 210 and a network 215. The message flow of FIG. 2 shows messages exchanged between an UE 210 and various components of the network 215. In the embodiment illustrated in FIG. 2, there is no loss in connectivity between the UE 210 and the network, thus the UE 210 is successfully registered on network 215. The UE 210 may be substantially similar to the UE 110 of FIG. 1. The UE 210 includes at least an IMS layer 212, a data services layer 214, and a radio layer 216. In some embodiments, other communication protocol layers may be included (e.g., a transport layer or physical layer) and some layers may be included as part of larger layer protocols (e.g., the IMS layer 212 may be part of an application layer (not shown)). Each arrow represents a message 230-260 may represent an exchange of multiple session establishing messages between one or more layers of the UE 210 and a corresponding element of the network 215. Each collection of messages represents one or more signals exchanged in performing the process. For ease of explanation the number of entities shown has been limited, however, it will be understood that additional entities can be added or multiple entities combined consistent with the description herein.

Messages 230 are representative of acquiring access to the network 215 via AP 220. The radio layer 216 may be configured to exchange one or more messages with the AP 220 to acquire access to the network 215. For example, in some embodiments messages 230 are representative of acquiring an LTE radio connection with an eNodeB.

Messages 240 are representative of a procedure to attach the UE 210 to the network 215 and connect the IMS layer 212 to the packet data network (PDN). For example, once access is acquired based on the exchange of messages 230, the data services layer 214 and a data core network 222 exchange one or more messages 240 to establish a connection to the network 215 (e.g., network attach). The messages 240 may also be configured to connect the IMS layer 212 to the (PDN). In some embodiments, the data core network 222 may be a packet data network gateway (P-GW).

Messages 250 are representative of an exchange of messages to establish a registration session of the UE 210 on the network 215. For example, once the network attach and PDN connection are established by messages 240, the IMS layer 212 of the UE 210 and the IMS 224 of the network 215 may be configured to exchange messages to execute IMS registration of the UE 210 on IMS 224. In one embodiment, the IMS 224 may include a PCSCF component, and the IMS 224 and IMS layer 212 may be configured to exchange messages 250 using SIP to facilitate registration of the UE 210 on IMS 224.

Messages 260 are representative of an exchange of messages to initiate, modify, or complete a call or exchange messages between the UE 210 and another communication device on the network 215. For example, the UE 210 may initiate or perform a Voice over LTE (VoLTE) call or other data transfer. In some embodiments, once registration is complete following messages 250, the IMS layer 212 and the IMS 224 may be configured to exchange messages to initiate, perform, or complete the call or data exchange. In one embodiment, the messages 260 represents an exchange of messages configured to initiate, modify, or complete the call or data exchange. In some embodiments, the exchange of messages 230-260 may occur prior to a successful phone call from the UE 210.

In certain situations the wireless communications network 215 may experience outages in connectivity or a loss of connectivity between UE 210 and the network 215. For example, the acquire radio access and network attach procedures depicted as messages 230 and 240 may be executed and performed as described above with reference to FIG. 2. However, a loss of connectivity may occur following the network attach procedures that inhibits the transmission of messages between the IMS layer 212 and the IMS 224, thereby failing to successfully establish registration session. The loss of connectivity may be due to a loss of a connection between the radio layer 216 and the AP 220, or may be due to a loss of connection between the data services layer 214 and the data core network 222. For example, the IMS layer 212 may send a message to perform registration which must traverse the multiple layers of the UE 210, originating at the IMS layer 212. Accordingly, the IMS layer 212 sends the message to the data services layer 214, which transmits the message to the radio layer 216. However, in a situation where a loss in connectivity occurs, for example, the UE 210 is out-of-service or any other temporary issue with the connectivity, the message may fail to be transmitted over the network 215.

Due to the abstraction of the various layers of the communication protocol stack and that, in typical implementations, each layer makes determinations on what to do with each message independent of information from other layers, from the point of view of the IMS layer 212 the message was successfully sent to the data services layer 214, and the IMS layer 212 does not receive an indication that the message was not successfully sent to the network 215. However, the message is queued in the buffers of one or more lower layers of the communication protocol stack, such as, for example, at the data services layer 214 and/or the radio layer 216 where the lower layer waits until connectivity is restore to send or abort the message according to the protocol of that layer. In some implementations the lower layers may be configured to independently decide whether to abort delayed messages when the messages are delayed. For example, there may be a predetermined timeout period included in the protocol of each layer, where, once a message is queued in the buffer of that layer for the an amount of time equal to or greater than the timeout period, the layer may determine to abort the message regardless as to whether the message remains valid or not.

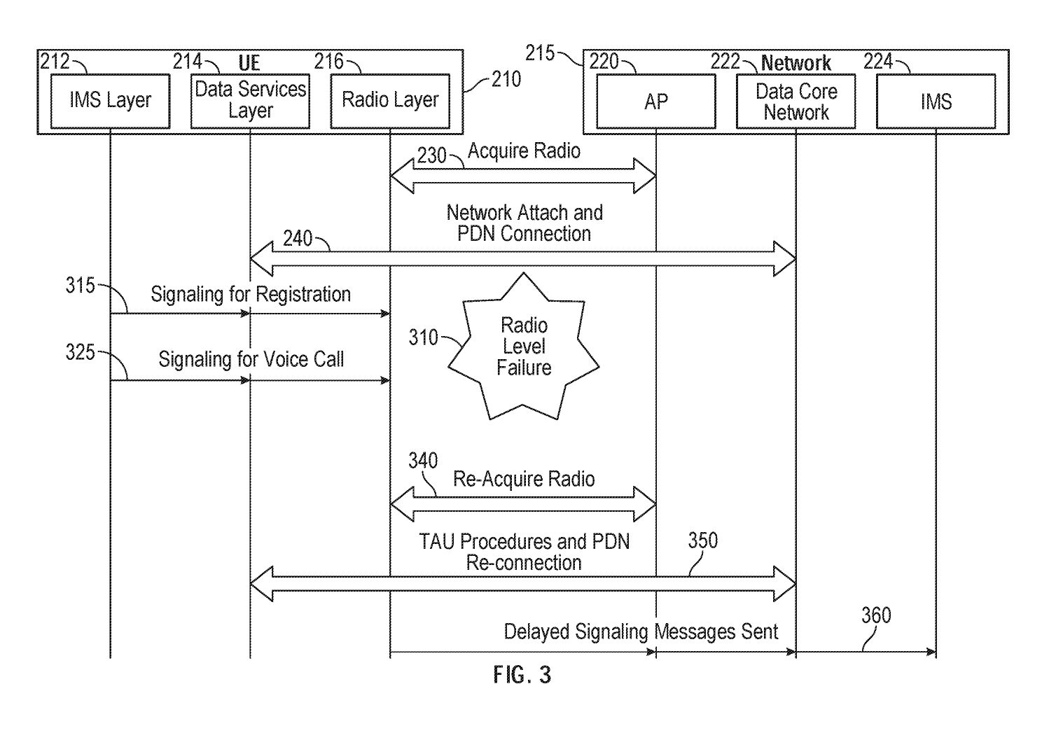

FIG. 3 illustrates an example message flow of a radio-level failure. The message flow of FIG. 3 depicts a temporary loss of connectivity to the network 215 that may occur between the radio layer 216 and AP 220 (e.g., a radio-level failure). Similar to the message flow of FIG. 2, FIG. 3 depicts that the network access is successfully acquired through the exchange of messages 230 and the network attach and PDN connection to the IMS 224 is successful through the exchange of messages 240. Each collection of messages represents one or more signals exchanged in performing the process. For ease of explanation the number of entities shown has been limited, however, it will be understood that additional entities can be added or multiple entities combined consistent with the description herein.

However, prior to the IMS layer 212 sending a message to IMS 224, a radio-level failure 310 may occur where the radio layer 216 losses the connection to the AP 220. In this instance, the IMS layer 212 transmits a message to the data services layer 214. The message may be further transmitted to the radio layer 216. In one embodiment, the IMS layer 212 may transmit a message 315 to signal for registration on the IMS 224. The message 315 may traverse the layers of UE 210 by being forwarded by the data services layer 214 to the radio layer 216. In another embodiment, the IMS layer 212 may transmit a message 325 to signal for a voice call or other action over network 215. The message 325 may traverse the layers of UE 210 by being forwarded by the data services layer 214 to the radio layer 216.

Due to the radio-level failure 310, any messages transmitted from the layers of UE 210 are held at the radio layer 216 and queued in the buffers of the radio layer 216 for transmission when the connectivity is reestablished. In one embodiment, the IMS layer 212 is only aware that message 315 was successfully sent to the data services layer 214. The IMS layer 212 is unaware that message 315 or 325 are held or queued at the radio layer 216. In one embodiment, the messages delayed due to being held and queued at the radio layer 216 may be one or more messages similar to messages 315 or 320 transmitted by the IMS layer 212. In another embodiment, the messages queued at the radio layer 216 may be any message transmitted from an upper layer for transmitting over the network 215.

At a point in time later, the conditions causing the loss in connectivity may no longer exist and the connection between the radio layer 216 and the AP 220 may be re-acquired through the exchange of messages 340. Messages 340 may be similar to the messages 230 used to initially acquire radio access. The data services layer 214 may re-attach to the network 215 through the exchange of messages 350. In one embodiment, the messages 350 exchanged are similar to messages 240. In another embodiment, the messages 350 effectuate a tracking area update or a routing area update to re-connect the PDN to the IMS layer 212. The IMS layer 212 may also be re-connected to the IMS 224. Following the connection of the IMS layer 212 with the IMS 224, any messages queued in the buffer of the radio layer 216 are sent over the network 215 having been delayed due to the radio-level failure, as illustrated by messages 360.

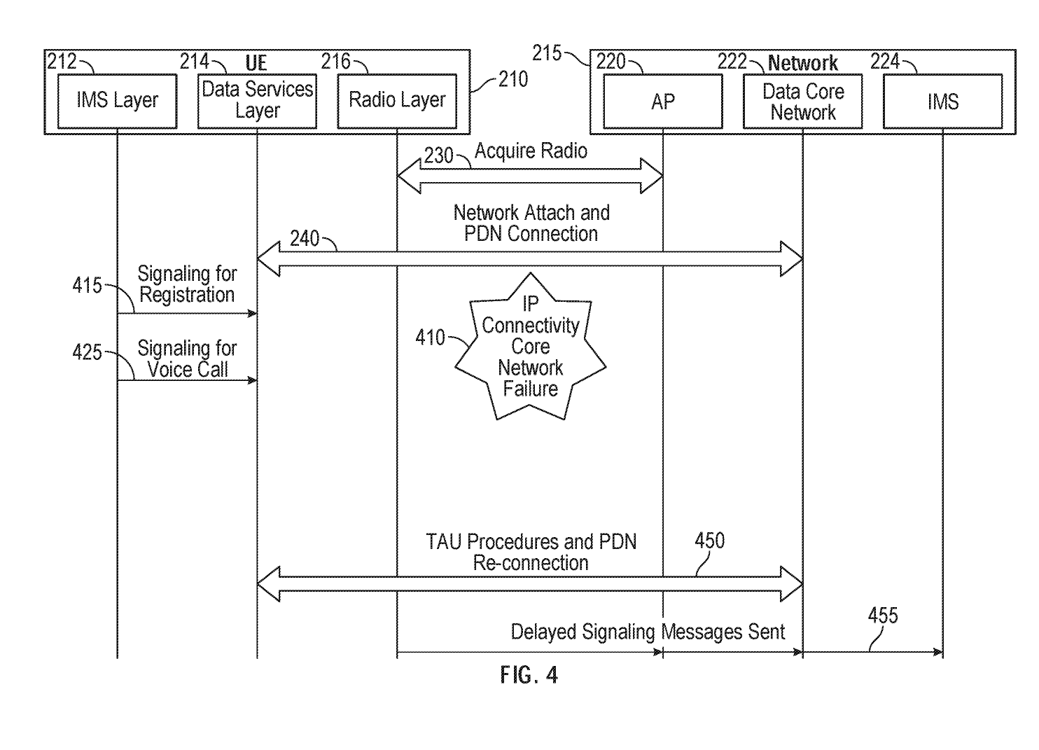

In another example, FIG. 4 illustrates an example message flow of an IP connectivity failure. FIG. 4 is substantially similar to FIG. 3, however, the temporary loss of connectivity to the network 215 occurs between the data services layer 214 and the data core network 222. This may be referred to as an IP connectivity failure. The message flow of FIG. 4 proceeds similar to that described with reference to FIG. 3, however, the messages are held up at the data services layer 214 and are queued in the buffers of data services layer 214 for sending when the connectivity issue is resolved. In one embodiment, the IMS layer 212 is aware that the message 415 was successfully sent to the data services layer 214. The IMS layer 212 is unaware that the message 415 or 425 are held or queued at the data services layer 214.

At a point in time later, the conditions causing the loss in connectivity may no longer exist and the connection between the data services layer 214 and the data core network 222 may be re-acquired through the exchange of messages 450. The data services layer 214 may re-attach to the network 215 through the exchange of messages 450. In one embodiment, the messages 450 exchanged are similar to messages 240. In another embodiment, the messages 450 effectuate a tracking area update or a routing area update to re-connect the PDN to the IMS layer 212. The IMS layer 212 may also be re-connected to the IMS 224. Following the connection of the IMS layer 212 with the IMS 224, any messages queued in the buffer of the data services layer 214 are sent over network 215 having been delayed due to the IP connectivity failure, as illustrated by messages 455.

In some implementations of wireless communication networks, there are certain scenarios where it may not be desirable to send the delayed messages after a given duration of time elapses after a loss in connectivity. For example, in certain situations the original condition for sending the message may no longer be valid or the message may no longer be applicable. Such conditions may be referred to as a “trigger condition.” Alternatively, there are other scenarios where it may be necessary to send the message even if it is delayed. Some implementations of wireless communication networks, do not differentiate between these two scenarios. In these implementations, all messages are treated equally and messages that are no longer valid or duplicative may be sent along with messages that remain valid following the loss in connectivity. Some implementations of the communication protocol stack may include layer protocol separation, where each layer of the communication protocol stack independently determines whether to send or abort a message based on the signaling protocol associated with a given layer. These implementations lack the ability to communicate between different layers, because each layer is following its given signaling protocol. Further, in some implementations the layers are located on different processors that may or may not be manufactured by the same vendor, which may cause further complexities in communication between the various layers.

One non-limiting advantage of certain embodiments, is that the IMS layer of a UE may be configured communicate with other layers within the communication protocol stack. The IMS layer may be configured to evaluate or determine whether to send a message even if the message has been delayed or queued in the buffers of one or more of the other layers of the communication protocol stack. In some embodiments, the message utilizes SIP, which is specific to the IMS layer. In these embodiments, only the IMS layer is configured to interpret and communicate using the SIP message, for example, the IMS layer is configured to determine whether messages using SIP are valid to be sent over the network after re-establishing connectivity between a UE and a network. Other layers of the communication protocol stack may not be configured to interpret the message using SIP and therefore would be unable to make such a determination. Some aspects of certain embodiments disclosed herein include the following.

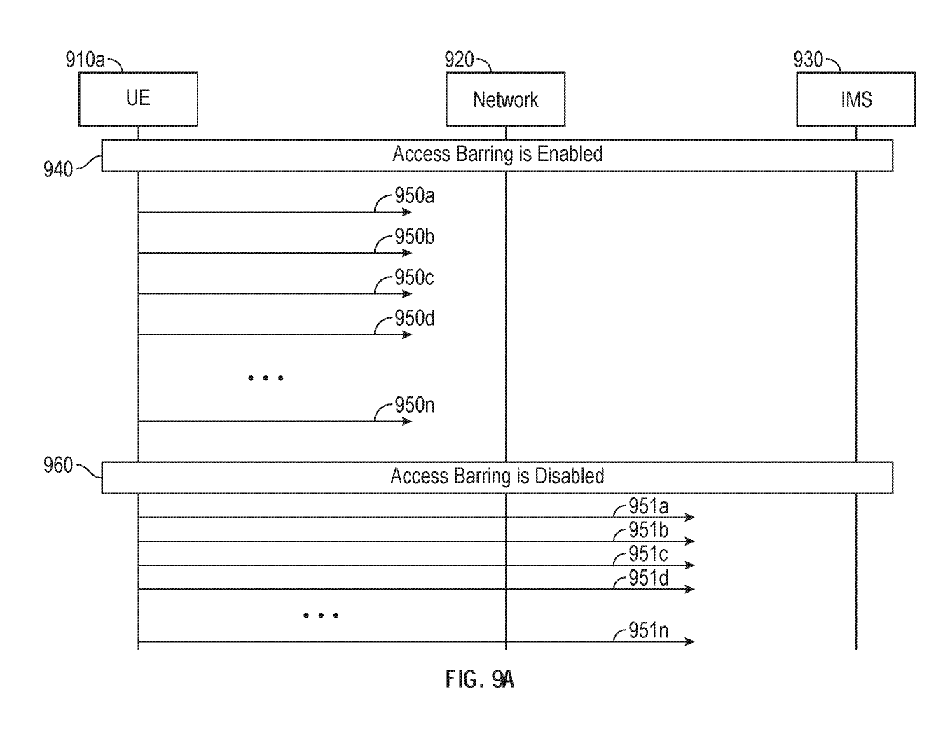

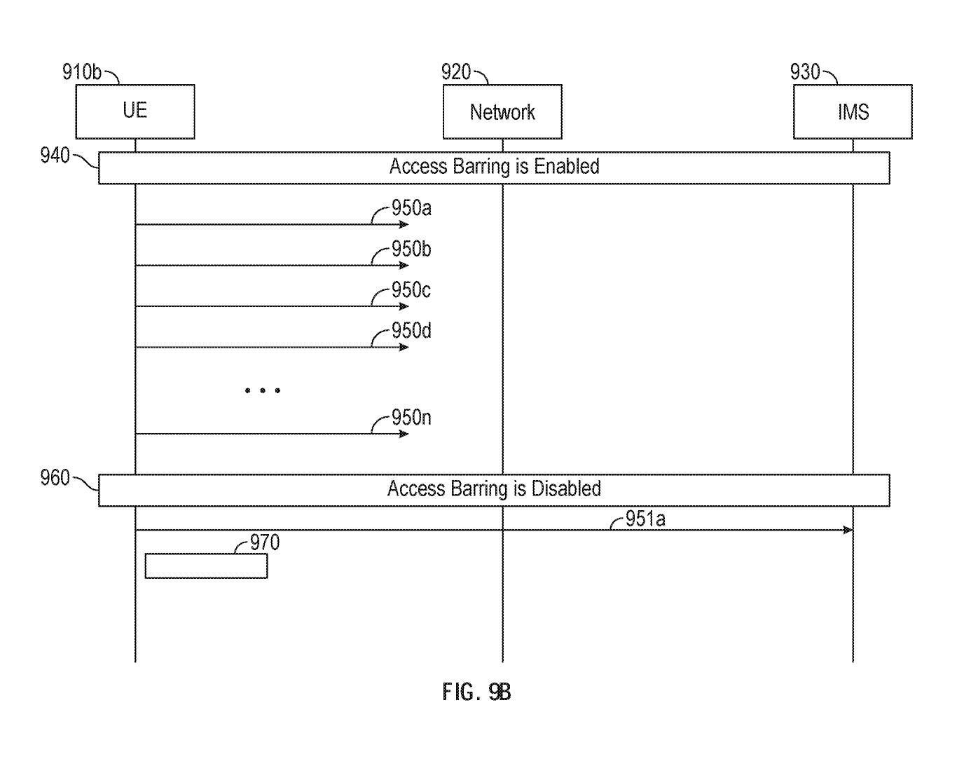

In one embodiment, the UE, or components of the UE, is configured to identify one or more trigger conditions to determine to send or abort messages following a delay at one or more of the layers of the communication protocol stack. In some implementations, the UE is configured to differentiate between different conditions to cause the message to be sent or aborted (e.g., deleted, flushed, cleared, etc.) of one or more queued messages. Exemplary trigger conditions and scenarios are described in more detail below with reference to FIGS. 9A-11B.

In another embodiment, the IMS layer of the UE may also be configured to communicate the decision to send or abort the delayed messages to other layers of the communication protocol stack. For example, the IMS layer may be configured to issue an abort command message based on the determination. Each layer may be further configured to, based on the received communication from the IMS layer, communicate the decision down the chain through the multiple layers of the communication protocol stack. In certain implementations, this may not be straightforward because various layers may reside on different processors within the UE utilizing different communication standards and protocols. For example, the IMS layer may be located on an application processor while the radio layer may be located on a processor including a cellular modem. Other arrangements are possible as well. In some embodiments, the data services layer may or may not be located at a processor including the cellular modem. In some embodiments, the IMS layer may be configured to communicate the decision to send or abort delayed messages to layers on separate processors.

In another embodiment, the lower layers of the communication protocol stack, such as the data services and radio layers, may be configured to receive communications from the IMS layer and execute one or more methods to identify a one or more messages from a group of multiple delayed messages. The lower layer may also be configured to abort the one or more identified messages. In some embodiments, the identification of the delayed messages may be based on a message identifier included in the header of an abort command message received at the lower layer from the IMS layer. The lower layer may be configured to compare the multiple delayed messages with the command message to identify the one or more delayed message to determine to identify and abort the one or more delayed messages. One non-limiting advantage of the embodiments disclosed herein, is cross layer communication between the various layers of the communication protocol stack within the UE to determine to send or abort messages received from upper layers.

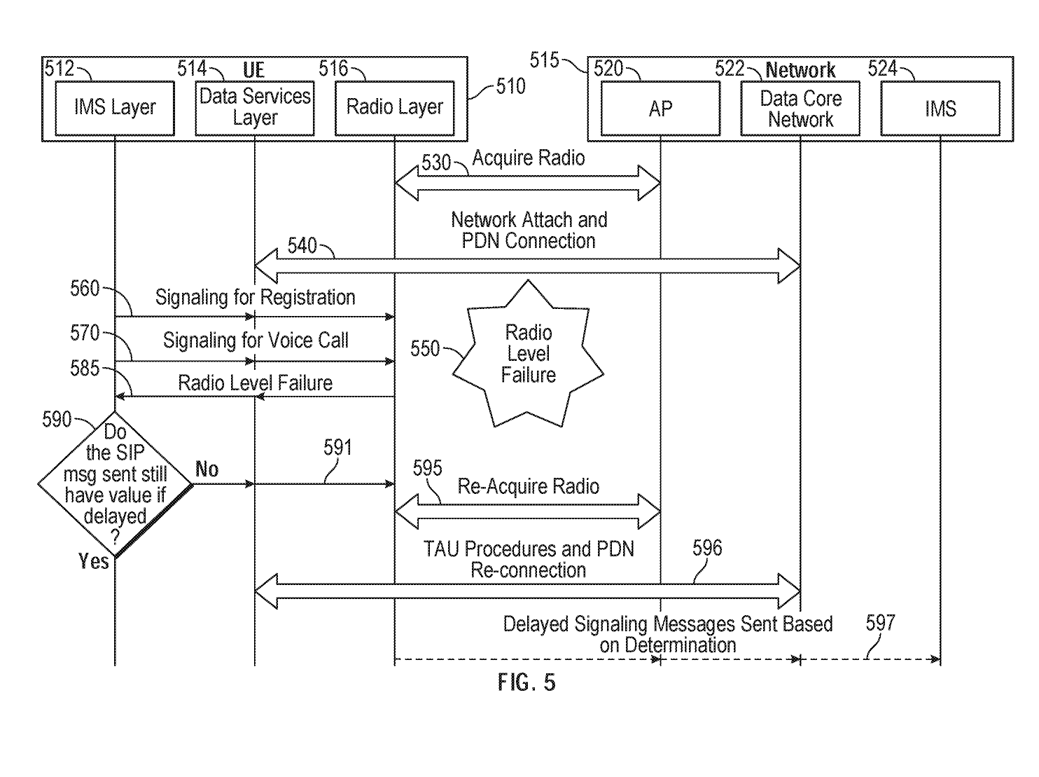

FIG. 5 illustrates an example message flow for aborting delayed messages due to a radio-level loss in connectivity. Each collection of messages represents one or more signals exchanged in performing the process. For ease of explanation the number of entities shown has been limited, however, it will be understood that additional entities can be added or multiple entities combined consistent with the description herein. The message flow illustrated in FIG. 5 may proceed in a substantially similar manner to the message flow illustrated in FIG. 3. For example, access to AP 520 may be successfully acquired through messages 530 and the UE 510 successfully attaches to the network 515 and PDN connection to the IMS layer 512 is successful through the exchange of messages 540. The IMS layer 512 may be configured to issue message 560 (messaging to establish a registration session between IMS layer 512 and IMS 524) or 570 (messaging to signal for a voice call or other action over network 515). At a point prior to the IMS layer 512 sending a message 560 or 570, a radio-level failure 550 occurs, similar to radio-level failure 310, where the radio layer 516 losses connection to the AP 520. As illustrated in FIG. 5, the IMS layer 512 successfully sends messages 560 or 570 to the data services layer 514 which are forwarded to the radio layer 516. The message 560 may traverse the layers of UE 510 by being forwarded by the data services layer 514 to the radio layer 516.

Due to the radio-level failure 550, message 560 and/or 570 may be held at the radio layer 516 and queued in the buffers to be sent when the connectivity issue is resolved. In contrast to the message flow of FIG. 3, radio layer 516 may be configured to send a message 585 to the data services layer 514 and then to the IMS layer 512 indicative of radio-level failure 550. The IMS layer 512 may be configured to receive the message from one or more of the other layers of the communication protocol stack. For example, the IMS layer 512 may be configured to receive a message either from the data services layer 514 or directly from the radio layer 516 notifying the IMS layer 512 of radio-level failure 550. Upon receiving the message 585, the IMS layer 512 may be configured to determine whether delayed messages 560 and/or 570 have value in being transmitted to the network 515 following the delay. The evaluation of whether a message has value may be based on trigger conditions as will be described in more detail below with reference to FIGS. 9A-11B.

In some embodiments, the delayed messages 560 and/or 570 may utilize SIP. Such messages are specific to the IMS layer 512 of the communication protocol stack and the IMS layer 512 is configured to interpret and communicate using such messages. Conversely, the radio layer 516 is not configured with the capability or protocols to interpret or utilize the messages 560 and/or 570 when the messages follow SIP. As such, the IMS layer 512, after receiving message 585, determines whether the delayed messages using SIP remain valid to be sent over the network. In certain implementations, the IMS layer 512 may be configured to identify the occurrence of a trigger condition at determination block 590. Based on the identified trigger condition, the IMS layer 512 may determine whether to abort or send the delayed messages 560 or 570. Where the decision is YES (e.g., the message has value even if delayed), the IMS layer 512 does nothing with respect to the particular message, and the message remains queued in the buffer of the radio layer 516 to be sent once connectivity is re-established. Where the decision is NO, the IMS layer 512 is configured to send a command to one or more layers instruction the one or more layers to abort the identified message. For example, the IMS layer 512 may be configured to send a message including a FLUSHPKT identifier included for example in the header information of message 591. This identifier may be configured to indicate to the one or more layers of the communication protocol stack as to which messages queued in the buffers of the radio layer 516 are to be aborted. Based on the received message 591, the radio layer 516 may be configured to identify the message and to abort the identified messages. In some embodiments, the determination block 590 may be performed on a message by message basis by the IMS layer 512. In other embodiments, the determination may be made with respect to a single message or a group of two or more messages.

At a point in time later, the connection between the radio layer 516 and the AP 520 may be re-acquired through the exchange of messages 595. The messages 595 may be similar to the messages 530 used to initially acquire radio access. The data services layer 514 may re-attach to the network 515 through the exchange of messages 596. In one embodiment, the messages 596 are similar to messages 540. In another embodiment, the messages 596 effectuate a tracking area update or a routing area update to re-connect the PDN to the IMS layer 512. The IMS layer 512 may also be re-connected to the IMS 524. Following the connection of the IMS layer 512 with the IMS 524, the radio layer 516 may be configured to transmit the messages queued in the buffers of radio layer 516 that are were not aborted, as illustrated by messages 597.

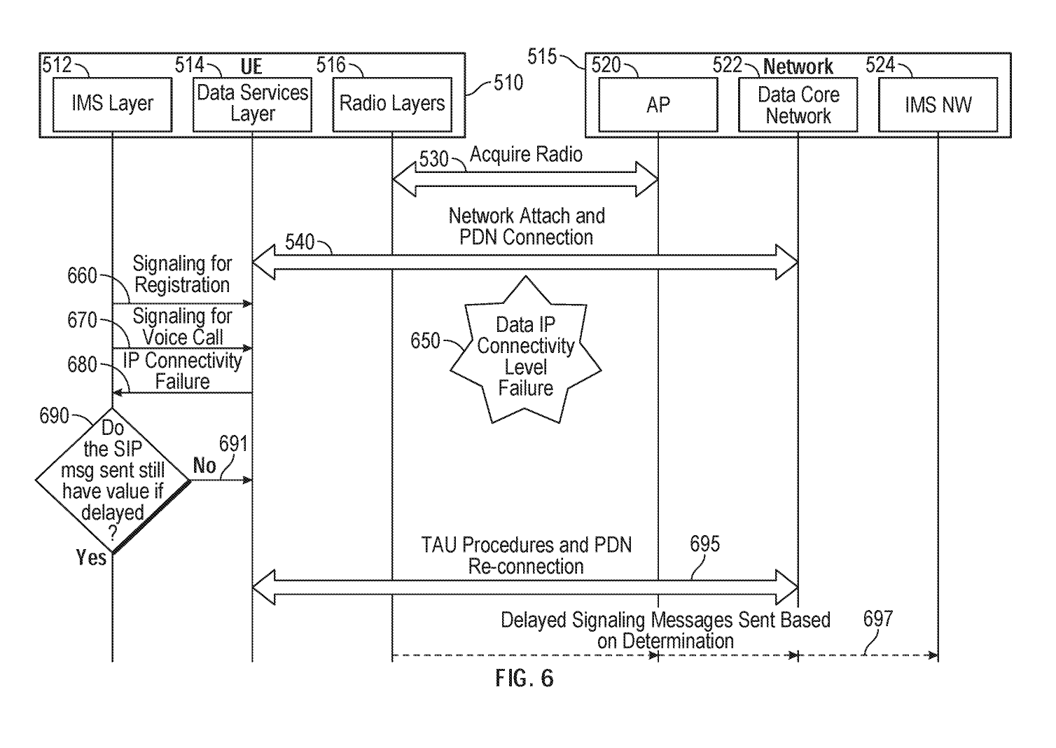

FIG. 6 illustrates an example message flow for aborting delayed messages due to an IP connectivity failure. Each collection of messages represents one or more signals exchanged in performing the process. For ease of explanation the number of entities shown has been limited, however, it will be understood that additional entities can be added or multiple entities combined consistent with the description herein. In the embodiment depicted in FIG. 6, the messages 660 and/or 670 may be queued in the buffer of the data services layer 514. Further, the message 680 indicating a loss of IP connectivity 650 may be communicated by the data services layer 514 to the IMS layer 512 in a similar manner as described above with reference to message 585 of FIG. 5. Further still, the determination that the message 660 and/or 670 has value may be communicated from the IMS layer 512 to the data services layer 514 as message 691. Otherwise, the message flow of FIG. 6 and information transmitted is similar to that described above with reference to FIG. 5.

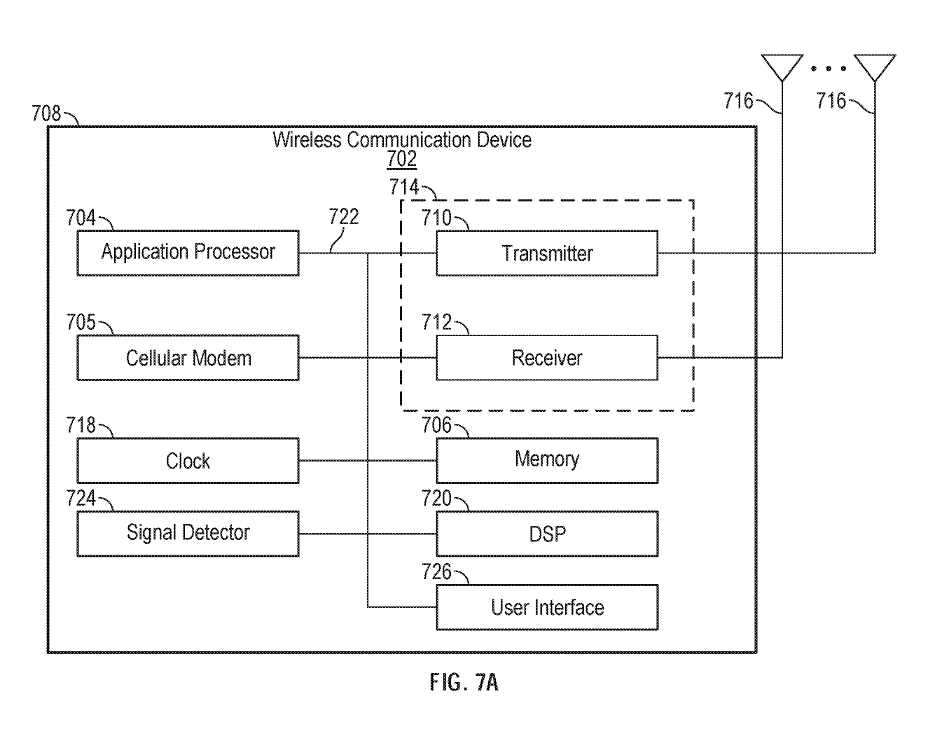

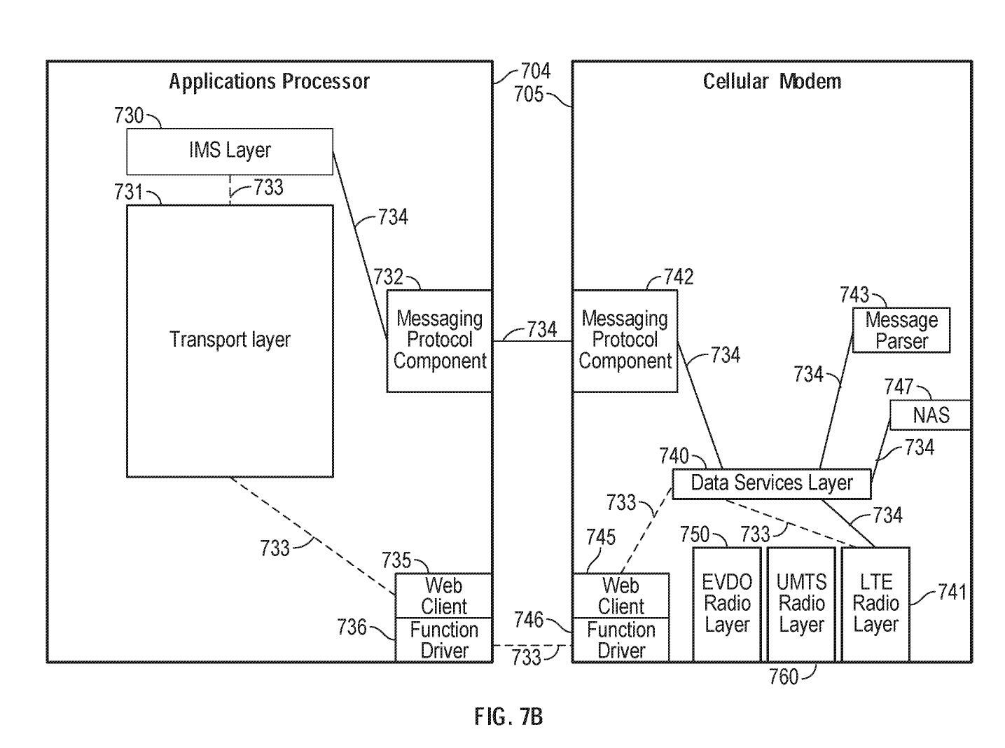

FIG. 7A is an example of a functional block diagram illustrating various components that may be utilized in a wireless communication device 702. Wireless communication device 702 may be employed within a wireless communication network, such as network 515 of FIGS. 5 and 6. The wireless communication device 702 is an example of a device that may be configured to implement the various methods described herein. The wireless communication device 702 may be implemented as an UE or other wireless communication device as described herein.

The wireless communication device 702 may include multiple processors and components. In one embodiment, the wireless communication device 702 includes a first and second processor. For example, as illustrated in FIG. 7A, the wireless communication device 702 may include an application processor 704 which controls certain high level application operations of the wireless communication device 702. The wireless communication device 702 may also include a cellular modem 705 which may be configured to control the lower level operations for controlling the communication of the wireless communication device 702 and the wireless communication network. The operations and functions of the application processor 704 and cellular modem 705 will be described in more detail below with reference to FIG. 7B.

The application processor 704 and cellular modem 705 may comprise or be a component of a processing system implemented with one or more processors. The one or more processors may be implemented with any combination of general-purpose microprocessors, microcontrollers, digital signal processors (DSPs), field programmable gate array signal (FPGA), programmable logic devices (PLDs), controllers, state machines, gated logic, discrete hardware components, dedicated hardware finite state machines, or any other suitable entities that can perform calculations or other manipulations of information. The various layers of a communication protocol stack may be configured into one or more of the application processor 704 and/or cellular modem 705 as described below with reference to FIG. 7B. In some embodiments, application processor 704 and cellular modem 705 are separate processors as depicted in FIGS. 7A and 7B. In other embodiments, application processor 704 and cellular modem 705 may represent different functionalities on a single processor.

The wireless communication device 702 may also include a memory 706, which may include both read-only memory (ROM) and random access memory (RAM). Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein. Accordingly, the processing system may include, e.g., hardware, firmware, and software, or any combination therein. The memory 706 may be configured to provide instructions and data to the application processor 704 or cellular modem 705. A portion of the memory 706 may also include non-volatile random access memory (NVRAM). The application processor 704 or cellular modem 705 may perform logical and arithmetic operations based on instructions stored within the memory 706. The instructions in the memory 706 may be executable to implement the methods described herein. The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein. In some embodiments, the memory 706 may store one or more delayed messages that is pending in the buffers of one or more layers of the communication protocol layers.

The wireless communication device 702 may also include a housing 708 that may include a transmitter 710 and a receiver 712 to allow transmission and reception of data between the wireless communication device 702 and a remote location, such as for example an AP of a wireless communication network. The transmitter 710 and receiver 712 may be combined into a transceiver 714. A single or a plurality of transceiver antennas 716 may be attached to the housing 708 and electrically coupled to the transceiver 714. The wireless communication device 702 may also include (not shown) multiple transmitters, multiple receivers, and multiple transceivers.

The transmitter 710 can be configured to wirelessly transmit messages to the components of a wireless communication network. In some embodiments, the successful transmission of messages is indicative that the wireless communication device 702 is connected to a wireless communication network. For example, the transmitter 710 can be configured to transmit messages generated by the application processor 704 and/or cellular processor 705. When the wireless communication device 702 is implemented or used as a UE 110 of FIG. 1, the transmitter 710 can be configured to transmit messages from the radio layer 116 to an AP 131. In some embodiments, the transmitter may be part of the physical layer 118 of FIG. 1.

The receiver 712 can be configured to wirelessly receive messages from the wireless communication network. When the wireless communication device 702 is implemented or used as UE 110 of FIG. 1, the receiver can be configured to receive messages or requests for data from the network 120, either in response to a transmitted message or as an initial message. For example, the wireless communication device 702 can be configured to utilize transmitter 710 and receiver 712 to send and receive messages described with respect to FIGS. 2-6 and 9A-11B. In some embodiments, the receiver 712 is configured to receive an acknowledge message indicative of a message being successfully transmitted by the transmitter 710 to the wireless communication network.

The wireless communication device 702 may also include a signal detector 724 that may be used in an effort to detect and quantify the level of signals received by the transceiver 714. The signal detector 724 may detect such signals as total energy, energy per subcarrier per symbol, power spectral density and other signals. The wireless communication device 702 may also include a digital signal processor (DSP) 720 for use in processing signals. The DSP 720 may be configured to generate a packet for transmission. In some aspects, the packet may comprise a physical layer data unit (PPDU).

The wireless communication device 702 may include a clock 718. The clock 718 may be configured continuously update the internal time in the memory 706 of the wireless communication device 702. The processor 704 may continuously check or utilize the internal clock time.

The wireless communication device 702 may further comprise a user interface 726 in some aspects. The user interface 726 may comprise a keypad, a microphone, a speaker, and/or a display. The user interface 726 may include any element or component that conveys information to a user of the wireless communication device 702 and/or receives input from the user.

The various components of the wireless communication device 702 may be coupled together by a bus system 722, which may include a power bus, a control signal bus, and a status signal bus in addition to a data bus.

FIG. 7B is an example of a functional block diagram illustrating an application processor 704 and cellular modem 705 that may be utilized in the wireless communication device 702 of FIG. 7A. The embodiment shown in FIG. 7B illustrates a UE in the form of wireless communication device 702 having one or more layers of the communication protocol stack located on separate processors. In one embodiment, application processor 704 may include the IMS layer 730, a transport layer 731, a messaging protocol component 732, and a web client 735. The IMS layer may be substantially similar to the IMS layer 512 as described above with reference to FIGS. 5 and 6. The cellular modem 705 may include the data services layer 740, the radio layer 741, a web client 745, a messaging protocol component 742, a message parser 743, and a network access server 747. FIG. 7B also depicts a data path 733 as a dotted line and a control path 734 as a solid line. In one embodiment, the data path 733 illustrates the logical path that messages are transmitted within the application processor 704 to the cellular modem 705 and to the network via the radio layer 741.

In some embodiments, the cellular modem 705 may also include multiple radio layers 741, 750, and 760. In one embodiment, radio layer 741 may represent a radio layer 741 configured to transmit data over a LTE network using PDCP+, RLC+, MAC+, or LI communication protocols. Radio layers 750 and 760 may be configured to transmit over legacy networks, such as 3G networks. For example, radio layer 750 may be a 1×EV-DO (EVDO) 3G standard for CDMA based legacy networks and radio layer 760 may be a Universal Mobile Telecommunications Service (UMTS) 3G broadband packet based transmission network. While the description herein refers to radio layer 741, it will be understood that the methods and devices described herein may be equally applicable to radio layers 750 and 760.

In some embodiments, messaging protocol components 742 and 732 may represent components that define the interface between the cellular modem 705 and the attached application processor 704, respectively. For example, the messaging protocol component 732 may be a Qualcomm® MSM Interface (QMI) that defines the interface between the MSM (e.g., cellular modem) and the wireless communication device. The QMI may be a messaging protocol to expose various functionalities of the cellular modem to the application processor and vice versa, and one or more functionalities of the network that the wireless communication device 702 is connected too. In some embodiments, the messaging protocol components 742 and 732 may represent one means for facilitating the communication of command messages along control path 734 between the various layers of the communication protocol stack located on separate processors.

In some embodiments, web clients 735 and 745 may represent a web client interface between the application processor 704 and cellular modem 705, respectively. The web clients 735 and 745 may be an interface for use in a messaging protocol component framework for facilitating the exchange of messages between the application processor 704 and the cellular modem 705. For example, the web clients 735 and 745 may be an RmNet interface for use in a QMI framework for facilitating the exchange of messages between the application processor 704 and the cellular modem 705. In this embodiment, the QMI may facilitate the commands and control of the transfer of messages along control path 734 and the RmNet may be configured to facilitate the actual transfer of the messages along the data path 733. In some embodiments, the web clients 735 and 745 may include one or more function drivers 736 and 746. For example, an RmNet uses two function drivers using a surface-mount device (SMD) interface or secure digital input output (SDIO) interface. The SMD interface may be configured to use a shared memory for the web client driver to communicate with the cellular modem. The SDIO interface may be configured to act as a link for communication of the function driver with the cellular modem.

In operation, FIG. 7B depicts application processor 704 including the IMS layer 730 configured to exchange command messages (over the control path 734) and messages (over the data path 733) to the various layers of the communication protocol as described above with reference to FIGS. 5 and 6. For example, following the data path 733, the IMS layer 730 may exchanges messages with the transport layer 731. In one embodiment the transport layer 731 may be a TCP stack, a User Datagram Protocol (UDP), or IP stack. The transport layer 731 may be configured to exchange messages with the web client 735 driven by function driver 736. The function driver 736 of application processor 704 is configured to interface with the function driver 746 of the cellular modem 705 to facilitate the exchange of the messages between the application processor 704 and the cellular modem 705. Upon reception of the message at the function driver 746, the web client 745 is configured to exchange data with the data services layer 740. The data services layer 740 then exchanges the message with the radio layer 741, 750, and/or 760.

In some embodiments, command messages are transmitted along the control path 734 configured to communicate instructions and control parameters between the various layers and processors. For example, command messages issued by the IMS layer 730 to abort or send messages from the radio layer 741 or data services layer 740, in accordance with the description with reference to FIGS. 5 and 6, may be transmitted along the control path 734. In some embodiments, the control path 734 may be configured to communication and exchange command messages to determine and instruct lower layers as to which message to abort. For example, the application processor 704 and cellular modem 705 include messaging protocol components 732 and 742, respectively, configured to enable communication between the different processors. The IMS layer 730 may be configured to send a command message to the messaging protocol component 732 to abort an identified message, the message having been transmitted along the data path 733. The messaging protocol component 732 may then interface with the messaging protocol component 742 to transmit the command to the data services layer 740.

In certain situations, the data services layer 740 may be configured to carry out the command. For example, where the command includes instructions to abort a delayed message held in the buffer of the data services layer 740, the data services layer 740 can be configured to communicate with the message parser 743 to identify the message and abort the identified message. The message may include an identifier in the header to facilitate the identification of particular messages, and the abort command message may include a similar identifier to associate a command with a particular message. Accordingly, the data services layer 740 and/or message parser 743 may be configured to compare the identifier of the command message with the identifier of the message to identify the message designated to be aborted. Alternatively, where the command message includes instructions to abort messages held in the buffer of the radio layer 741, the data services layer 740 may be configured to communicate the command message to the radio layer 741, and the radio layer 741 may then act on the command in a substantially similar manner as to that described with reference to data services layer 740.

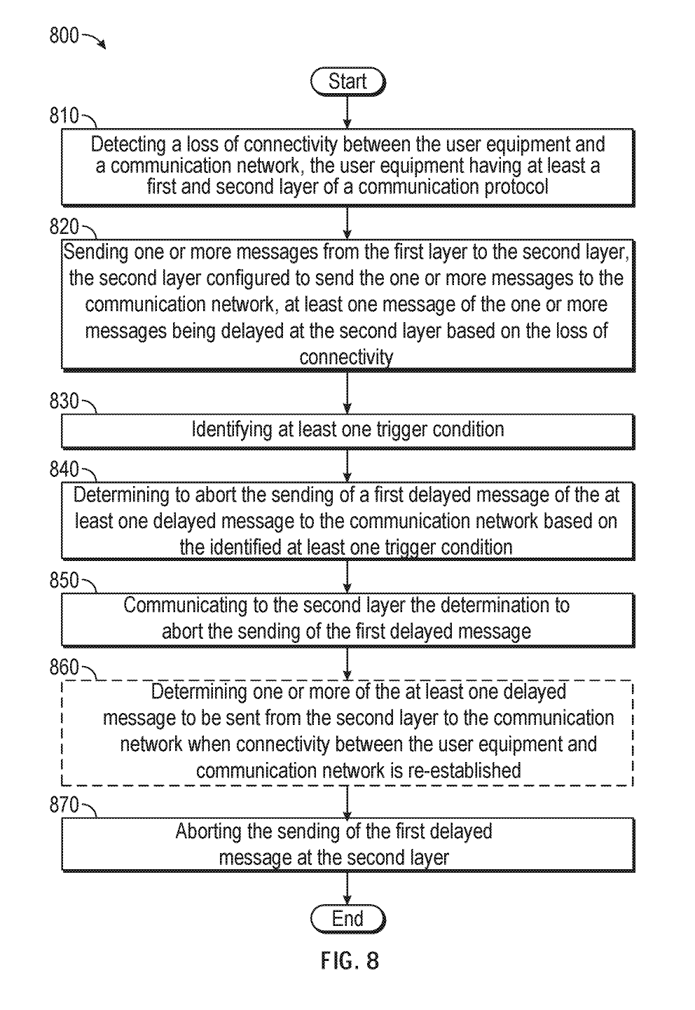

FIG. 8 illustrates a process flow diagram of a method 800 for wireless communication. The method 800 may be implemented in whole or in part by, or in connection with, the devices described herein such as the UE, APs, and network components shown in FIGS. 5-7B. Those having ordinary skill in the art will appreciate that other components may be used to implement one or more of the steps described herein. Although blocks may be described as occurring in a certain order, the blocks can be reordered, blocks can be omitted, and/or additional blocks can be added. Also, while the following description mentions a first and second layer of a communication protocol stack, one skilled in the art will understand that a communication protocol stack may include more than two layers and the terms first and second are not intended to be limiting to the total number of layers included in the communication protocol stack.

At block 810, a loss of connectivity between the user equipment and a communication network is detected, the user equipment having at least a first and second layer of a communication protocol. In one embodiment, the communication protocol stack may include multiple layers, not limited to a first and second layer. The communication protocol stack may include an IMS layer, a data services layer, and a radio layer, however one skilled in the art will understand that the communication protocol stack may not be limited to those layers and may include any number of layers. In one embodiment, the first layer may be an IMS layer. In another embodiment, the first layer may be any layer or a combination of layers of the communication protocol stack. In one embodiment, the second layer may be the data services layer. In another embodiment, the second layer may be the radio layer. In one embodiment, the loss of connectivity may be due to a radio-level failure, where the radio layer is disconnected from the access point of the network. For example, as described in reference to FIGS. 3 and 5. In another embodiment, the loss of connectivity may be due to an IP connectivity failure where the data services layer is disconnected from the core network. For example, as described in reference to FIGS. 4 and 6. In one embodiment, the user equipment is configured to detect the occurrence of a loss in connectivity at the one or more layers.

At block 820, one or more messages are sent from the first layer to the second layer. In one embodiment, the second layer is configured to send the one or more messages to the communication network, at least one message of the one or more messages being delayed at the second layer based on the loss of connectivity. In one embodiment, the one or more messages are delayed at the second layer as a result of the loss of connectivity. In one embodiment, the one or more messages may be messages utilizing SIP and transmitted from an IMS layer to a data services layer and radio layer, whereby the messages are intended to be transmitted over the wireless communication network. The SIP messages may be delayed for the reasons describe above with reference to FIGS. 3-6.

At block 830, the first layer may identify at least one trigger condition. Trigger conditions may be any such condition indicative for a basis of delaying a message, such that the first layer may be configured to determine the basis for the delay. Exemplary trigger conditions are described in more detail below with reference to FIGS. 9A-11B, however, one skilled in the art will understand that the exemplary trigger conditions are illustrative and that other conditions are applicable.

In some embodiments, the first layer is an IMS layer, similar to the IMS layer 512 of FIGS. 5 and 6, and the a least one delayed message may be an SIP message. In this embodiment, the SIP message includes a payload that only the IMS layer is configured to interpret and utilize. The second layer is not configured with the protocols to understand what is included in the SIP message payload. Thus, the IMS layer in this configuration is able to interpret the payload of the SIP message to determine whether a trigger condition exists.

At block 840, the first layer may determine to abort the sending of a first delayed message of the at least one delayed message based on the identified at least one trigger condition. In one embodiment, the first layer may determine to abort the sending of a first delayed message of the at least one delayed message where the purpose for initially sending the message is no longer applicable. For example, during the loss in connectivity multiple duplicative messages may be sent, and only the one of the duplicative messages may be necessary upon re-establishing connectivity with the network. Therefore, the first layer may be configured to determine to abort at least one of the duplicative messages while determining to do nothing or issue a command to transmit at least one of the messages once connectivity is restored. In one embodiment, the first layer may determine to abort at least one of the messages and issue a command to the second layer indicating such in accordance with FIGS. 5 and 6.

At block 850, the first layer may communicate to the second layer the determination to abort the sending of the first delayed message. In one embodiment, the first layer may issue instructions or command messages to the second layer according to FIGS. 5, 6, 7A and 7B. In one embodiment, the command to clear may be a FLUSHPKT command included in the header of a command message transmitted from the first layer to the second layer. The second layer may be configured to utilize header information and identifiers in the command message to locate messages to be aborted.

At optional block 860, one or more of the at least one delayed message may be determined to be sent from the second layer to the wireless communication network when connectivity between the user equipment and the communication network is re-established. In one embodiment, the second layer may determine to transmit the one or more of the at least one delayed message based on a messaging protocol independently associated with the second layer. In another embodiment, the first layer may issue a command message indicating to the second layer to transmit one or more of the at least one delayed message to either another layer of the communication protocol stack or transmit the one or more of the at least one delayed message over the wireless communication network.

In some embodiments, the first layer is an IMS layer, similar to the IMS layer 512 of FIGS. 5 and 6, and the delayed messages may be SIP messages. In this embodiment, the SIP message includes a payload that only the IMS layer is configured to interpret and utilize. The second layer is not configured with the protocols to understand what is included in the SIP message payload. In this embodiment, at block 830, the IMS layer is able to interpret the payload of the SIP message to determine whether a trigger condition exists. At block 840, the IMS layer interprets the payload of the delayed SIP message and determines whether the payload remains valid or is to be aborted. This decision is then communicated to the second layer by the IMS layer at blocks 850 and optional block 860.

At block 870, the second layer may abort the sending of the first delayed message. In one embodiment, the second layer may be configured to receive the command message from the first layer including the determination to abort the sending of the first delayed message. The second layer may be configured to effectuate the command message by aborting the message. For example, the message may be cleared from the memory or buffers of the second layer or the second layer may be configured to abort the first delayed message and other delayed messages either individually or as an identified group of messages.

The following embodiments may represent a non-exhaustive list of example trigger conditions for differentiating scenarios to determine whether to abort the sending of the first delayed message delayed by being queued at different layers of the communication protocol stack within the UE. Further, these methods may also represent methods that may be used to determine whether the messages should be sent even if delayed.

FIG. 9A illustrates an example message flow of multiple IMS registration messages transmitted during a loss in connectivity indicative of a trigger condition. The message flow of FIG. 9A illustrates messages exchanged between a UE 910a and various components of the wireless communications network 920. Each collection of messages represents one or more signals exchanged in performing the process. For ease of explanation the number of entities shown has been limited, however, it will be understood that additional entities can be added or multiple entities combined consistent with the description herein. In one embodiment, the message flow of FIG. 9A is substantially similar to the message flow of FIGS. 5 and 6 where the UE 510 attempts to register on IMS 524. For example, UE 910a may include multiple layers of a communication protocol stack and the network 920 may include an AP, data core network, and the IMS 930. In some embodiments, the IMS 930 may be a PCSCF as described above with reference to FIGS. 1-3.

In the embodiment illustrated in FIG. 9A, the network 920 may be configured to enable an access barring event 940. In one embodiment, the access barring event 940 may be enabled following the network attach and PDN connection procedure between the UE 910a and the network 920, where the network attach and PDN connection procedure are substantially similar to those described with reference to FIGS. 5 and 6. In one example, the access barring event may be performed to facilitate load balancing on the network 920 to control data flow between the network 920 and various communication devices on the network 920. In one embodiment, the access barring event 940 may be considered a radio-level failure, whereby the network 920 disconnects UE 910a from the access point of the network 920. In one embodiment, the access barring event 940 is a temporary event. In another embodiment, the access barring even 940 may be considered an IP connectivity failure, whereby the network 920 disconnects the UE 910a from the data core network.

During access barring event 940, the UE 910a may be unable to transmit messages over network 920. In one embodiment, the UE 910a may be blocked from sending registration messages over the network 920 to the IMS 930 to complete IMS registration. However, the IMS layer of UE 910 may not be notified of the access barring event 940, thus the IMS layer of UE 910 may attempt to send a first registration message 950a. Registration message 950a may be queued in one or more layers of the UE 910a due to the access barring event 940. For example, the registration message 950a may be queued in a data services layer or radio layer of the UE 910. While registration message 950a is queued, the IMS layer of UE 910 is unaware of that the message is held in queue, but is aware that the registration of the UE 910a on the IMS 930 has not been completed because an acknowledge message or registration successful message has not been received by the IMS layer. Thus, the IMS layer of UE 910a may be configured to send duplicative registration retry messages 950b-950n to attempt to complete the registration. Each of registration retry messages 950b-950n are also queued in the buffers of one or more layers of the UE 910.

At a point in time later, the access barring event is disabled as illustrated event 960. Upon disabling the access barring event, the registration message 950a and registration retry messages 950b-950n are all transmitted from the one or more layers of UE 910a to the network 920. In some implementations, this message dump results in a flooding of messages 951a-951n at the IMS 930 due to the multiple registration messages 950a-950n all being sent at one instance. Therefore, in some embodiments, where the IMS layer of UE 910a sends multiple registration messages without reception of a message indicative of a successful registration with IMS 930 may be an exemplary trigger condition applicable to the methods and devices described above with reference to FIGS. 5-7B.

In SIP, messages sent on UDP may be retried periodically per SIP standards outlined in RFC 3261. For example, RFC 3261 defines multiple timers for sending SIP registration retry messages. These times include, at least, a time T1, a second time T2, and a time out time TF. A registration message may be retried periodically at a times T1, 2×T1, 4×41, etc., until the internal clock of the UE 910a reaches time T2, and then the UE 910a retries at times T2, 2×T2, 4×T2, etc. until the internal clock reaches time TF. In one embodiment, T1 may be 2 seconds, T2 may be 16 seconds and TF may be 128 seconds, and this would result in approximately eleven SIP registration messages being queued before the internal clock reaches time TF. If access barring is enabled by the network 920, each of these SIP registration messages are held at one or more layers of the UE 910a, such as the radio or data services layer. Once access barring is disabled and after another period of time, for example a predetermined registration transaction time out period, all of the queued SIP registration messages are sent to the IMS 930. In some embodiments, the SIP registration messages are sent to a PCSCF. This dump of all of SIP registration messages results in the flooding of the IMS 930 with SIP registration messages at the PCSCF server where multiple communication devices may try to register or transfer data all at once.

FIG. 9B illustrates an example message flow of an implementation of the trigger condition of FIG. 9A in accordance with the methods and deceives described herein. The message flow of FIG. 9B illustrates an exchange of messages that occurs when the IMS layer of UE 910b is configured to identify a trigger condition and determine whether to abort one or messages that may be queued in the buffers of one or more layers of the communication protocol stack of UE 910b. The IMS layer of UE 910b may be configured to issue command message 970 to one or more other layers of the communication protocol stack instructing the one or more layers to abort sending messages determined to no longer be necessary for wireless communication.

For example, the IMS layer of UE 910b may be configured to associate each registration message 950a-950n with a message identifier. In some embodiments, the message identifier may be P1, however, it will be understood that any identifier will be applicable that enable the identification of one or more delayed messages. The IMS layer may be configured to identify the trigger condition, as described above with reference to FIG. 9A, and determine to abort the one or more queued registration messages 950a-950n delayed in the buffers of one or more of the layers of UE 910b based on removing duplicative message identifiers. In this regard, one or more layers of UE 910b may be configured to compare the identifiers of each message to determine whether there more than one messages having the same identifier and, if so, issue a command message including instructions to abort duplicative messages. The determination may be made at the first layer of the UE 910b, where the first layer may be configured to communicate this determination to the lower layers of the UE 910b, for example, via a control path that is similar to the control path 734 of FIG. 7B. In this way, once access barring is disabled at event 960, only one message 951a is sent to the network while retries are cleared or aborted for a given message identifier. One non-limiting advantage of this message flow is that it avoids flooding the IMS 930 with multiple duplicative messages when access barring is disabled.

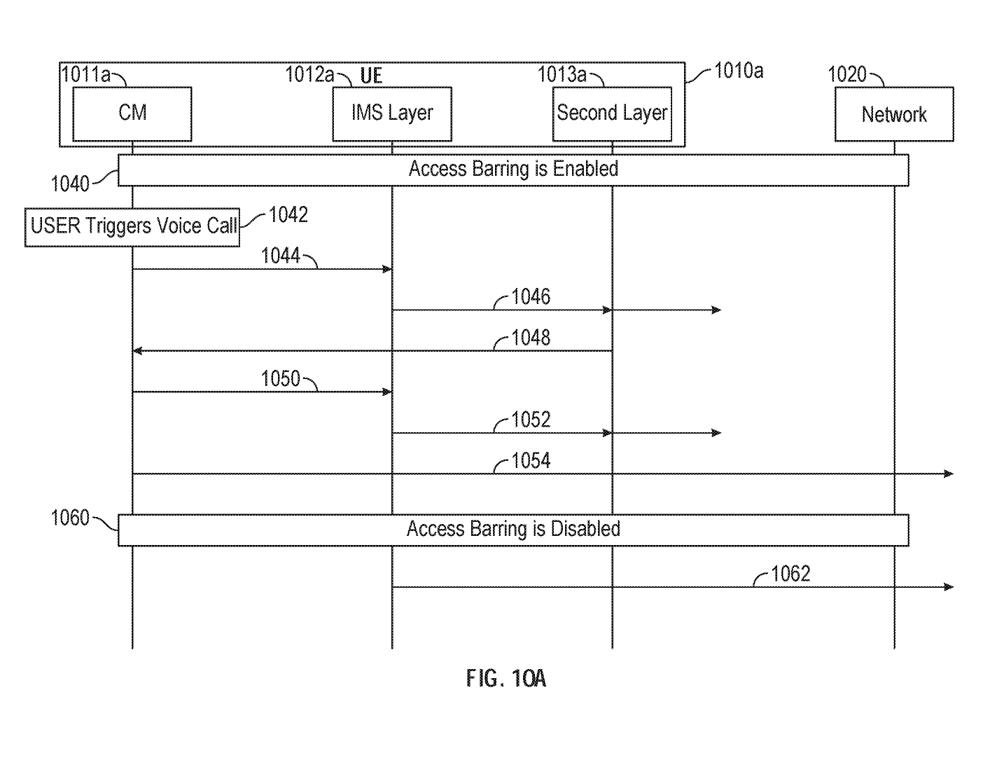

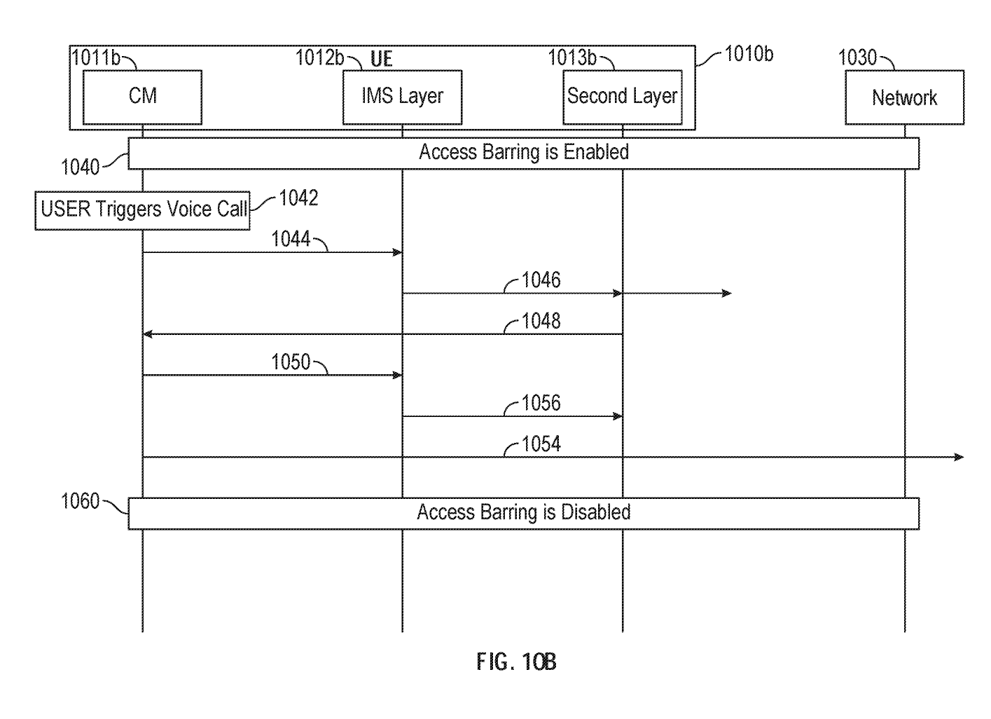

FIG. 10A illustrates another example message flow of a scenario where multiple data transfer request messages are transmitted during a temporary loss in connectivity indicative of another trigger condition. The message flow of FIG. 10A illustrates messages exchanged between an UE 1010a and a network 1020. For ease of explanation the number of entities shown has been limited, however, it will be understood that additional entities can be added or multiple entities combined consistent with the description herein. In the embodiment of FIG. 10A, the network 1020 may be a data packet-based network. In one embodiment, the message flow of FIG. 10A is substantially similar to the message flows of FIGS. 2-4 where the UE 210 attempts to initiate a voice call or other transfer of data on the network 215. For example, UE 1010a may include multiple layers of a communication protocol stack. As illustrated in FIG. 10A, the UE 1010a includes an IMS layer 1012a and a second layer 1013a. The second layer 1013a may represent multiple layers of the communication protocol stack or a single layer, such as, a radio layer or a data services layer that are substantially similar to the radio layer 216 or the data services layer 214 of FIGS. 2-4. The UE 1010a may also include a call manager 1011a configured to receive a call request from a user of UE 1010a and issue messages to facilitate establishing a transfer of data over the network 1020. In some embodiments, the call manager 1011a may be located on a separate layer of the communication protocol stack. In another embodiment, the call manager 1011a may be located at an application layer of the communication protocol stack. FIG. 10A also includes a wireless communications network 1020 which may include an access point (e.g., AP 220 of FIG. 2-4), a data core network (e.g., data core network 222 of FIG. 2-4), and an IMS (e.g., IMS 224 of FIG. 2-4).

In the embodiment illustrated in FIG. 10A, the network 1020 may be configured to enable access barring event 1040. The access barring event 1040 may be substantially similar to the access barring event 940 of FIGS. 9A and 9B. In one embodiment, the access barring event 1040 may be enabled following the network attach procedure performed in a substantially similar manner as those described with reference to FIGS. 5 and 6. In one example, the access barring event 1040 may be performed to facilitate load balancing on the network 1020 to control data flow between communication devices on the network 1020. In one embodiment, the access barring event 1040 may be considered a radio-level failure, whereby the network 1020 disconnects the UE 1010a from the access point of the network 1020. In another embodiment, the access barring event 1040 may be considered an IP connectivity failure, whereby the network 1020 disconnects the UE 1010a from the data core network.

While the access barring event 1040 is enabled, the UE 1010a may attempt to make a voice call or transfer data to another communication device. For example, the user triggers a VoIP over the data network by initiating a VoIP call event 1042. The user may operate the UE 1010a by inputting a request for a voice call connection with a contact or a dialed number. The message sequence that the UE 1010a executes when a user initiates VoIP call event 1042 is as follows: the call manager 1011a sends a call origination indication message 1044 to the IMS layer 1012a. The IMS layer 1012a sends an INVITE message 1046 to the second layer 1013a, and the second layer 1013a attempts to forward the INVITE message 1046 to the network 1020.

However, due to access barring event 1040, INVITE message 1046 is not successfully transmitted to the network 1020 but is delayed and queued in the buffers of second layer 1013a. The second layer 1013a receives a notification from the network 1020 indicative of a notification that the INVITE message 1046 was unsuccessful or that access barring is enabled. In one embodiment, the notification is in the form of a return EWOULDBLOCK message from the network 1020 to the second layer 1013a indicating that the UE 1010a is barred from accessing the network 120. In another embodiment, the call manager 1011a may perform one or more retry INVITE messages (not shown) which are each delayed and held in the buffer of second layer 1013a.

In response to the unsuccessful transmission of INVITE message 1046 or retry INVITE messages, the second layer 1013a issues a rejection notification 1048. The rejection notification 1048 is received by the call manager 1011a, having been forwarded through the various layers of the communication protocol stack of UE 1010a. The rejection notification 1048 may cause the call manager 1011a to send a call END message 1050 to the IMS layer 1012a including of instructions to end the voice call request. The IMS layer 1012a may then trigger a CANCEL request message 1052 toward the network 1020. However, the CANCEL request message 1052 is also queued at the second layer 1013a due in part to the unsuccessful transmission of the original INVITE message 1046 to the network 1020 and in part due to access barring being enabled. As a result, the voice call triggered by the user is not performed over the network 1020, and the call manager 1011a performs a silent redial to retry the call via a circuit-switch fall-back (CSFB) procedure via message 1054. A CSFB procedure may be configured to facilitate transferring the voice call request to a legacy network and performing the request voice call over circuit-switched networks. In one embodiment, the call manager 1011a triggers the call END message 1050 to the IMS layer 1012a without intervention by the user within approximately 50 milliseconds and the voice call is retried over a CSFB-lx procedure.

At a point in time following message 1054, the network 1020 may disable access barring at event 1060. At this point, one or more INVITE messages 1046 delayed and queued in the buffers of second layer 1013a are sent over the network 1020 as illustrated as INVITE message 1062. In one instance, the CSFB voice call procedure initiated by message 1054 may be still be active, and a receiving communication device would receive the one or more delayed INVITE messages 1062 from the UE 1010a during the initiated the CSFB voice call. This may result in the receiving communication device receiving two voice calls at the same time, e.g., a CSFB call and a VoIP call, from the UE 1010a. Alternatively, where the CSFB voice call has ended, the receiving communication device may receive the one or more delayed INVITE messages 1062 followed by an immediate cancelling of the call via the queued CANCEL request message 1052. This may result in a ghost INVITE message 1062 for an already terminated voice call.

FIG. 10B illustrates example message flow of an implementation of the trigger condition of FIG. 10A in accordance with the methods and deceives described herein. The message flow of FIG. 10B may be similar to the message flow of FIG. 10A. The IMS layer 1012b may be similar to IMS layer 512 of FIGS. 5 and 6 and may be configured to track and record the outgoing INVITE message 1046. The IMS layer 1012b utilizes the header information of each message to keep track of outgoing INVITE messages 1046 to verify if the INVITE message 1046 has been transmitted to the network 1020. For example, the IMS layer 1012b may utilize a message identifier in the header of INVITE message 1046 and check whether the INVITE message 1046 is delayed and queued at second layer 1013b. When the call manager 1011b sends the call END message 1050, the IMS layer 1012b may be configured to check whether the INVITE message 1046 is queued at the second layer 1013b or if it has been successfully transmitted to the network 1020. If the INVITE message 1046 is queued, the IMS layer 1012b may be configured to send a delete command 1056 to the second layer 1013b to abort the queued INVITE message 1046 and end the voice call request session. One non-limiting advantage of this procedure may result in preventing an unwanted ghost INVITE messages 1046 from being sent to the network 1020 due to messages delayed following the network 1020 disabling access barring event 1060.

In the embodiment of FIG. 10B, the IMS layer 1012b may be configured to identify the trigger condition of FIG. 10A when the INVITE message 1046 is queued at the second layer 1013b and the second layer 1013b receives the CANCEL request message 1052 for the pending INVITE message 1046. The IMS layer 1012b may determine the INVITE message 1046 and CANCEL request message 1052 are to be aborted based on a comparison of message identifiers, whereby the identifiers are configured to associate the CANCEL request message 1052 with the pending INVITE message 1046. This determination can then be communicated to the second layer 1013b through command message 1056. Based on command message 1056, the second layer 1013b may be configured to abort the INVITE and CANCEL request messages 1046 and 1052.

In another embodiment of FIG. 10B, the IMS layer 1012b may be configured to identify the trigger condition of FIG. 10A when the INVITE message 1046 is queued at the second layer 1013b and the IMS layer 1012b receives the rejection notification 1048 for the pending INVITE message 1046. In some embodiments, the IMS layer 1012b may be configured to forward the rejection notification 1048 to the call manager 1011b. The IMS layer 1012b may determine to abort the INVITE message 1046 based on a comparison of message identifiers in the header of the INVITE message 1046 and rejection notification 1048. The message identifiers may be configured to associate the rejection notification 1048 are with the pending INVITE message 1046. This determination can then be communicated to the second layer 1013b through command message 1056 and the second layer 1013b may be configured to abort the INVTIE and CANCEL request messages 1046 and 1052 in response to the received command message 1056.

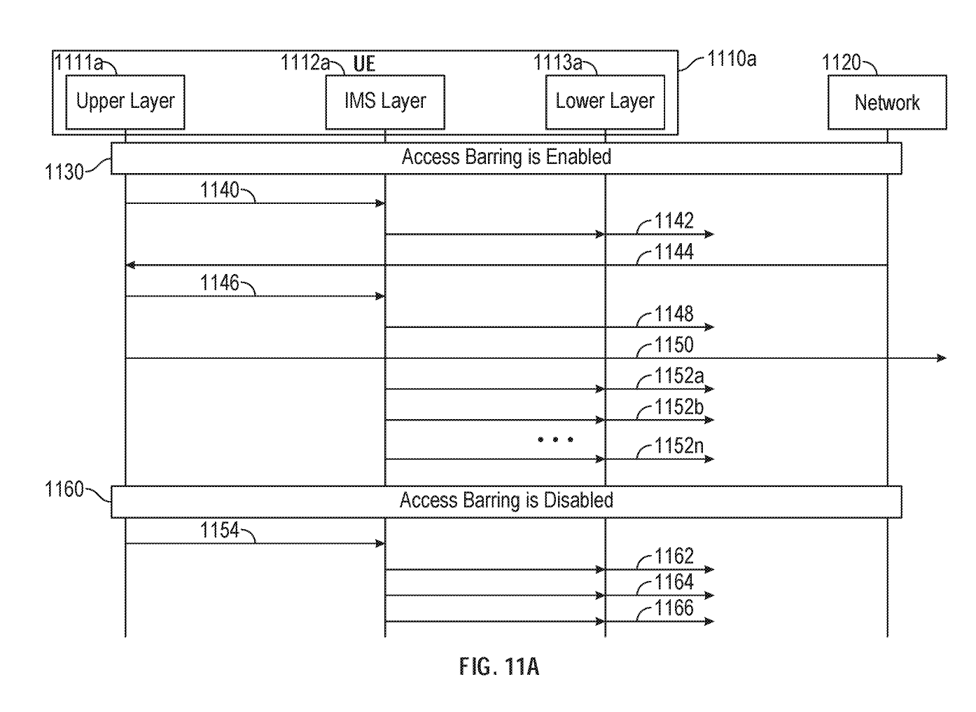

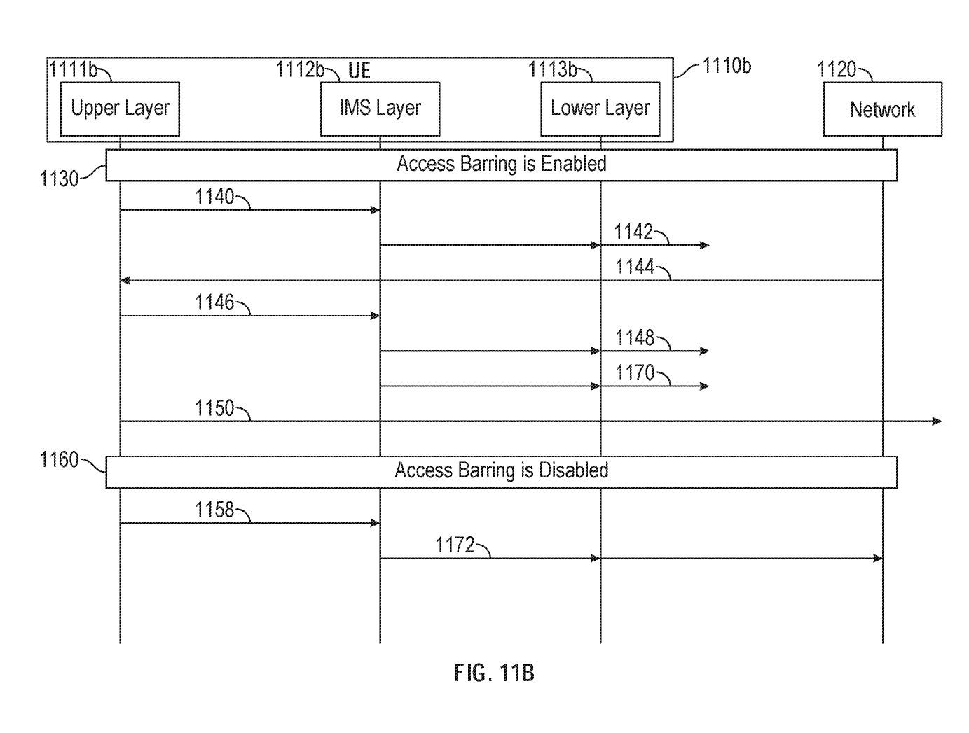

FIG. 11A illustrates another example message flow of a scenario where multiple connection messages are transmitted during a temporary loss in connectivity indicative of another trigger condition. The message flow of FIG. 11A illustrates messages exchanged between an UE 1110a and a wireless communication network 1120. For ease of explanation the number of entities shown has been limited, however, it will be understood that additional entities can be added or multiple entities combined consistent with the description herein. In one embodiment, the message flow of FIG. 11A is substantially similar to the message flow of FIGS. 2-4 where the UE 210 attempts to register on the IMS 224. For example, UE 1110 may include multiple layers of a communication protocol stack. As illustrated in FIG. 11A, the UE 1110a includes an IMS layer 1112a and a lower layer 1113a. The lower layer 1113a may represent multiple layers of the communication protocol stack or a single layer, such as, a radio layer or a data services layer that are substantially similar to the radio layer 216 and the data services layer of FIGS. 2-4. The UE 1110a may also include an upper layer 1111a. The upper layer 1111a may represent one or more upper layers configured to receive a voice call request from a user and issue commands to facilitate establishing a voice call over the network 1120. In some embodiments, the upper layer 1111a may be located on a separate layer of the communication protocol stack. In another embodiment, the upper layer 1111a may be located at an application layer of the communication protocol stack. FIG. 11A also includes a wireless communication network 1120 which may include an access point (e.g., AP 220 of FIGS. 2-4), a data core network (e.g., data core network 222 of FIGS. 2-4), and an IMS (e.g., IMS 224 of FIGS. 2-4).

In the embodiment illustrated in FIG. 11A, the wireless communication network 1120 may be configured to enable an access barring event 1130. The access barring event may be substantially similar to the access barring event 940 of FIGS. 9A and 9B. In one embodiment, the access barring event 1130 may be enabled following the network attach procedure performed in a substantially similar manner as those described with reference to FIGS. 2-4. In one example, the access barring event may be performed to facilitate load balancing on the network 1120 to control data flow to communication devices. In one embodiment, the access barring event 1130 may be considered a radio-level failure, whereby the network 1120 disconnects the UE 1110a from the access point of the network 1120. In another embodiment, the access barring event 1130 may be considered an IP connectivity failure, whereby the network 1120 disconnects the UE 1110a from the data core network.

While access barring event 1130 is enabled, the UE 1110a may attempt to make a voice call. In the embodiment illustrated in FIG. 11A, a user a call sequence is performed while accessing barring is enabled. For example, a user may trigger a VoIP over a data packet-based network by initiating a VoIP call, such as, by operating the UE 1110a by inputting a request for a VoIP connection with a contact or a dialed number. In response to initiating the VoIP call, the upper layer 1111a transmits a call origination request message 1140 to the IMS layer 1112a. Upon receiving the call origination request message 1140, the IMS layer 1112a attempts to initiate a TCP connection with the network 1120 by sending the TCP sync message 1142 over an RCC connection. In one embodiment, the TCP sync message 1142 includes an INVITE request message. In another embodiment, the TCP sync message 1142 and INVITE request message are separate messages.

However, due to access barring event 1130, the TCP sync message 1142 is not transmitted to the network 1120 and is queued in one or more buffers of the lower layer 1113a. In some embodiments, the TCP sync message 1142 is delayed at the lower layer 1113a because an RCC connection is not established between the UE 1110a and the network 1120 due to access barring event 1130. The IMS layer 1112a may receive a rejection notification 1144 from the lower layer 1113a. In one embodiment, the lower layer 1113a is a radio layer and the rejection notification 1144 is transmitted from radio layer to the IMS layer 1112a and forwarded to the upper layer 1111a. The rejection notification 1144 may cause the upper layer 1111a to send a call END message 1146 to the IMS layer 1112a indicative of instructions to end the call request. The IMS layer 1112a may then trigger a CANCEL request message 1148 toward the network 1120. However, the CANCEL request message 1148 is also queued at the lower layer 1113a due the access barring event 1130 and because the INVITE request message was never transmitted to the network 1120. As a result, the VoIP triggered by the user is not performed over the data packet-based network, and the upper layer 1111a performs a silent redial, following the call END message 1146, to try the voice call over CSFB via message 1150. In one embodiment, the call is performed over a CSFB-lx procedure.

In the embodiment of FIG. 11A, while the CSFB call is performed, the IMS layer 1112a may continue to attempt to establish a TCP connection by sending multiple TCP sync retry messages 1152a-1152n. Each TCP sync retry message 1152a-1152n may be delayed and queued in the buffers of the lower layer 1113a. At a point in time following message 1150, the network 1120 disables access barring at event 1160 and the CSFB call is completed. The access barring event may be disabled during the CSFB call or after the CSFB call is completed. In either case, the user may attempt to trigger a second VoIP call, whereby the upper layer 1111a transmits a subsequent call origination indication message 1154 to the IMS layer 1112a. In response to the subsequent call origination indication message 1154, the IMS layer 1112a attempts to establish a TCP connection by at message 1162 before sending a new INVITE request message 1166. However, due to the TCP sync retry messages 1152a-1152n being queued and pending in the buffer of lower layer 1113a, the number TCP sync retries are exhausted. In one embodiment, the TCP timeout period has not transpired during the preceding exchange of messages and the IMS layer 1112a remains idle waiting for a TCP connection with the network 1120. Thus, the IMS layer 1112a is unable to transmit a TCP sync message and establish a TCP connection prior to INVITE request message 1166. Since the IMS layer 1112a is unable to send a TCP retry message, the network 1120 and UE 1110a are unable to establish a TCP connection, and the TCP timeout period expires at event 1164. In this situation, the INVITE request message 1166 from the IMS layer 1112a fails to be transmitted to the network 1120 and the second VoIP call fails.

FIG. 11B illustrates example message flow of an implementation of the trigger condition of FIG. 11A in accordance with the methods and deceives described herein. The message flow of FIG. 11B may be similar to the message flow of FIG. 11A. However, the IMS layer 1112b may be similar to IMS layer 512 of FIGS. 5 and 6 and may be configured to identify the occurrence of the trigger condition of FIG. 11A. In one embodiment, the IMS layer 1112b may be configured to determine whether the TCP connection remains in a connection state following reception of a rejection notification 1144 from the network 1120 and/or a call END message 1146 from the upper layer 1111b. For example, the IMS layer 1112b may recognize the transmission of multiple TCP sync retry messages following reception of either rejection notification 1144 or call END message 1146. The IMS layer 1112b may also be configured to recognize the transmission of CANCEL request message 1148 while a TCP connection is in connection state as indicative of a trigger condition.

Following the identification of a trigger condition, the IMS layer 1112b is configured to check whether the TCP connection of the UE 1110b is in a pending connection state, and if so, close or reset the TCP connection by issuing a command message 1170 to the lower layer 1113b. The command message 1170 may be a TCP-FIN/RST message. The command message 1170 may be transmitted along with or shortly after the CANCEL request message 1148. The IMS layer 1112b may also cease sending TCP sync retry messages at this time as well. The IMS layer 1112b is may be further configured to determine whether there are any pending delayed TCP sync messages queued at the lower layer 1113a, and if so, abort one or more of the delayed pending TCP sync messages. In one embodiment, the command message 1170 includes instructions regarding the INVITE request message and CANCEL request message 1148 which would otherwise be queued in the lower layer 1113b for transmission once the access barring event is disabled. One non-limiting advantage of the embodiment described herein is that the IMS layer 1112b is able to determine to abort the TCP connection, abort all queued messages, and communicate the determination to the lower layer 1113b.

The voice call requested by the user may be completed through CSFB procedures initiated by message 1150 instead of over VoIP due to the access barring event 1130. Once the access barring event is disabled at event 1160, the UE 1110b is able to proceed with a second call request from the user over VoIP. For example, the upper layer 1111b may issue a second call origination indication 1158 to the IMS layer 1112b. In response to the second call origination indication 1158, the IMS layer 1112b may attempt a new TCP connection through message 1172 to send an INVITE request message 1142.

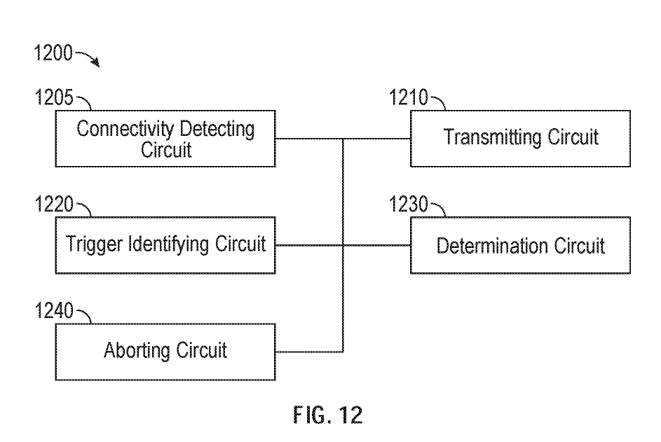

FIG. 12 is a functional block diagram of an UE that may be employed within the wireless communication system of FIG. 1. Those skilled in the art will appreciate that an access point may have more components than the simplified UE 1200 shown in FIG. 12. The UE 1200 shown includes only those components useful for describing some prominent features of implementations within the scope of the claims. The UE 1200 may include a connectivity detecting circuit 1205, transmitting circuit 1210, trigger identifying circuit 1220, determination circuit 1230, and aborting circuit 1240.

FIG. 12 is a functional block diagram of an UE that may be employed within the wireless communication system of FIG. 1. Those skilled in the art will appreciate that a UE may have more components than the simplified UE 1200 shown in FIG. 12. The UE 1200 shown includes only those components useful for describing some prominent features of implementations within the scope of the claims. The UE 1200 may include a connectivity detecting circuit 1205, transmitting circuit 1210, trigger identifying circuit 1220, determination circuit 1230, and aborting circuit 1240.

In some aspects, one or more of connectivity detecting circuit 1205, transmitting circuit 1210, trigger identifying circuit 1220, determination circuit 1230, and aborting circuit 1240 may be implemented as a single or multiple circuits within the UE.

In some implementations, the connectivity detecting circuit 1205 may be configured to perform one or more of the functions discussed above with respect to block 810. The connectivity detecting circuit 1205 may include one or more of a programmable chip, a processor, a memory, a receiver and a network interface. For example, the connectivity detecting circuit 1205 may include the application processor 704, transceiver 714, DSP 720, cellular modem 705, or the memory 706 of FIGS. 7A and 7B. In some implementations, means for detecting a loss of connectivity between the UE 1200 and the network may include the channel selecting circuit 1205. For example, in some embodiments, the connectivity detecting circuit 1205 may include the radio layer 741 of the cellular modem 705 configured to detect a loss in connectivity when an acknowledgement message is not received from the network in response to a message transmitted from one or more components of UE 1200. In another embodiment, the connectivity detecting circuit 1205 may include the signal detector 724 configured to evaluate signals received from the transceiver 714. For example, if the signal detector 724 determines the signal level received from the network is below a threshold, the connectivity detecting circuit may determine that the AP of the network is no longer transmitting to the UE 1200, thereby indicating that the UE 1200 is no longer connected to the network.

In some implementations, the transmitting circuit 1210 may be configured to perform one or more functions discussed above with respect to blocks 820 and 850. The transmitting circuit 1210 may include one or more of a programmable chip, a processor, a memory, a user interface, and a network interface. For example, the data transmitting circuit 1210 may include the application processor 704, cellular modem 705, and the memory 706 of FIGS. 7A and 7B, among others. In some implementations, means for sending one or more messages from the first layer to the second layer, means for transmitting the one or more messages from the second layer to the communication network, and/or means for communicating to the second layer may include the transmitting circuit 1210.

For example, means for sending one or more messages from the first layer to the second layer may be implemented by the transmitting circuit 1210 configured to transmit instructions from the IMS layer 730 of the application processor 704 of FIGS. 7A and 7B. Instructions from the IMS layer 730 may be included in the application processor 704 to transmit a data packet message from the IMS layer 730 to the radio layer 741 over data path 733 as described above with respect to FIG. 7B, and vice versa. Therefore, the application processor 704 may be one means for sending one or more messages from the first layer to the second layer. Similarly, instructions from the IMS layer 730 may be included in the application processor 704 to communicate command messages from the IMS layer 730 to the radio layer 741 over the data path 734 as described above with respect to FIG. 7B as well as FIGS. 5 and 6, and vice versa. Therefore, the application processor 704 may be one means for communication between the first and second layer the determination to abort the sending of delayed messages. Instructions from the radio layer 741 can be included in cellular modem 705 to transmit the message to the network 120 by utilizing transceiver 714. Therefore, the cellular processor may be one means for transmitting the one or more messages to the communication network.

In some implementations, the trigger identifying circuit 1220 may be configured to perform one or more functions discussed above with respect to block 830. Trigger identifying circuit 1220 may include one or more of a programmable chip, a processor, a memory, a user interface, and a network interface. For example, the trigger identifying circuit 1220 may include the application processor 704, cellular modem 705, the memory 706, and/or transceiver 714 of FIGS. 7A and 7B. In some implementations, means for identifying at least one trigger condition may include the trigger identifying circuit 1220. For example, as described above with respect to FIGS. 9A-11B, the IMS layer 730 of the application processor 704 may include instructions to identify that one or more messages are delayed within one or more layers of the communication protocol layers of the application processor 704 and/or cellular modem 705. The transceiver 714 may not transmit one or more messages that are pending within one or more communication protocol layers of the application processor 704 and/or cellular modem 705 because an acknowledge message is not received by the transceiver 714. The application processor 704 may be configured to perform functions of the UE 1200 in response to instructions in the IMS layer 730 based on scenarios and conditions described with respect to the message flow diagrams depicted FIGS. 9A-11B, among others. Therefore, the trigger identifying circuit 1220 may be one means for identifying at least on trigger condition.

In some implementations, the determination circuit 1230 may be configured to perform one or more of the functions discussed above with respect to block 840 and/or 860. The determination circuit 1230 may include one or more of a programmable chip, a processor, a memory, a receiver and a network interface. For example, the determination circuit 1230 may include the application processor 704, cellular modem 705, the transceiver 714, or the memory 706 of FIGS. 7A and 7B. In some implementations, means for determining to abort the sending of one or more delayed messages and/or means for determining one or more of the delayed messages to be sent to the communication network may include the determination circuit 1230. For example, the communication protocol layers of the application processor 704 and/or the cellular processor 705 may utilize the transceiver 714 to transmit and receive various messages. As described herein, the messages may include header information. The communication protocol layers of the application processor 704 and/or cellular modem 705 may include instructions to compare the header information and evaluate whether one or more messages is valid or necessary or otherwise is duplicative and/or no longer needed, for example, as described above with respect to FIGS. 9A-11B, among others. Therefore, determination circuit 1230 may represent one means for determining to abort and/or send one or more delayed messages.

In some implementations, the aborting circuit 1240 may be configured to perform one or more of the functions discussed above with respect to block 870. The aborting circuit 1240 may include one or more of a programmable chip, a processor, a memory, a receiver and a network interface. For example, the aborting circuit 1240 may include the application processor 704, cellular modem 705, or the memory 706 of FIGS. 7A and 7B. In some implementations, means for aborting the sending of one or more delayed messages may include the aborting circuit 1240. For example, based on a determination to abort sending a delayed message, the communication protocol of the application processor 704 and/or cellular modem 705 may include instructions to access the messages stored in the memory 706 and abort messages that are no longer valid or selected for aborting. In some embodiments, the instructions in the one or more layers of communication protocol layers may cause the application processor 704 and/or cellular modem 705 to clear all messages stored in the memory 706. In another embodiment, the instructions may cause the application processor 704 and/or cellular modem 705 to delete one or more messages having been identified as disclosed herein.

As used herein, the term interface may refer to hardware or software configured to connect two or more devices together. For example, an interface may be a part of a processor or a bus and may be configured to allow communication of information or data between the devices. The interface may be integrated into a chip or other device. For example, in some embodiments, an interface may comprise a receiver configured to receive information or communications from a device at another device. The interface (e.g., of a processor or a bus) may receive information or data processed by a front end or another device or may process information received. In some embodiments, an interface may comprise a transmitter configured to transmit or communicate information or data to another device. Thus, the interface may transmit information or data or may prepare information or data for outputting for transmission (e.g., via a bus).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of wireless communication, comprising:
detecting, at a user equipment, a loss of connectivity between the user equipment and a communication network, the user equipment having at least a first and second layer of a communication protocol;
sending one or more messages from the first layer to the second layer, the second layer configured to send the one or more messages to the communication network, at least one message of the one or more messages being delayed at the second layer based on the loss of connectivity;
identifying, at the first layer, at least one trigger condition;
determining, at the first layer, to abort the sending of a first delayed message of the at least one delayed message to the communication network based on the identified at least one trigger condition;
communicating, by the first layer, to the second layer the determination to abort the sending of the first delayed message; and
aborting the sending of the first delayed message at the second layer.

2. The method of claim 1, wherein the user equipment includes a plurality of processors, the first layer located on a first processor and the second layer located on a second processor.

3. The method of claim 1, further comprising determining, at the first layer, one or more of the at least one delayed message to be sent from the second layer to the communication network when connectivity between the user equipment and communication network is re-established.

4. The method of claim 1, wherein the loss of connectivity is based on an access barring procedure, the access barring procedure configured to block the user equipment from sending messages to the communication network.

5. The method of claim 4, wherein identifying at least one trigger condition includes the first layer sending the one or more messages during the access barring procedure, wherein each of the one or more messages is indicative of an attempt to register the user equipment on the communication network.

6. The method of claim 4, wherein identifying at least one trigger condition includes, at the second layer of the of the communication protocol, receiving a cancel request message and detecting the at least one delayed message, the at least one delayed message indicative of an invite request message, wherein the invite request message is indicative of the user equipment initiating a voice call and the cancel request message is indicative that the invite request message was blocked by the access barring procedure.

7. The method of claim 4, wherein identifying at least one trigger condition includes the first layer receiving a rejection notification based on the user equipment attempting to make a call during the access barring procedure while the at least one delayed message is delayed, the at least one delayed message being at least one pending TCP sync request message.

8. The method of claim 1, wherein aborting the sending of the first delayed message at the second layer comprises:
identifying the first delayed message by the second layer based on the determination communicated from the first layer; and
deleting the first delayed message by the second layer.

9. The method of claim 1, wherein the first layer is an IP multimedia subsystems (IMS) layer and the one or more messages are based on session initiation protocol (SIP).

10. A device for wireless communication comprising:
one or more processors configured to:
detect a loss of connectivity between the device and a communication network, the device having at least a first and second layer of a communication protocol;
send one or more messages from the first layer to the second layer, the second layer configured to send the one or more messages to communication network, at least one message of the one or more messages being delayed at the second layer based on the loss of connectivity;
identify, at the first layer, at least one trigger condition;
determine, at the first layer, to abort the sending of a first delayed message of the at least one delayed message to the communication network based on the identified at least one trigger condition;
communicate, by the first layer, to the second layer the determination to abort the sending of the first delayed message; and
abort the sending of the first delayed message at the second layer.

11. The device of claim 10, further comprising a plurality of processors, the first layer located on a first processor and the second layer located on a second processor.

12. The device of claim 10, wherein the one or more processors are further configured to determine, at the first layer, one or more of the at least one delayed message to be sent from the second layer to the communication network when connectivity between the device and communication network is re-established.

13. The device of claim 10, wherein the loss of connectivity is based on an access barring procedure, the access barring procedure configured to block the device from sending messages to the communication network.

14. The device of claim 13, wherein the at least one trigger condition includes the first layer sending the one or more messages during the access barring procedure, wherein each of the one or more messages is indicative of an attempt to register the device on the communication network.

15. The device of claim 13, wherein the at least one includes, at the second layer of the of the communication protocol, receiving a cancel request message and detecting the at least one delayed message, the at least one delayed message indicative of an invite request message, wherein the invite request message is indicative of the device initiating a voice call and the cancel request message is indicative that the invite request message was blocked by the access barring procedure.

16. The device of claim 13, wherein the at least one trigger condition includes the first layer receiving a rejection notification based on the device attempting to make a call during the access barring procedure while the at least one delayed message is delayed, the at least one delayed message being at least one pending TCP sync request message.

17. The device of claim 10, wherein the one or more processors are further configured:
identifying the first delayed message by the second layer based on the determination communicated from the first layer; and
deleting the first delayed message by the second layer.

18. The device of claim 10, wherein the first layer is an IP multimedia subsystems (IMS) layer and the one or more messages are based on session initiation protocol (SIP).

19. An device for wireless communication comprising:
means for detecting a loss of connectivity between the device and a communication network, the device having at least a first and second layer of a communication protocol;
means for sending one or more messages from the first layer to the second layer, the second layer configured to send the one or more messages to communication network, at least one message of the one or more messages being delayed at the second layer based on the loss of connectivity;
means for identifying, at the first layer, at least one trigger condition;
means for determining, at the first layer, to abort the sending of a first delayed message of the at least one delayed message to the communication network based on the identified at least one trigger condition;
means for communicating, by the first layer, to the second layer the determination to abort the sending of the first delayed message; and
means for aborting the sending of the first delayed message at the second layer.

20. The device of claim 19, further comprising a plurality of processors, the first layer located on a first processor and the second layer located on a second processor.

21. The device of claim 19, wherein the loss of connectivity is based on an access barring procedure, the access barring procedure configured to block the device from sending messages to the communication network.

22. The device of claim 21, wherein the at least one trigger condition includes the first layer sending the one or more messages during the access barring procedure, wherein each of the one or more messages is indicative of an attempt to register the device on the communication network.

23. The device of claim 21, wherein the at least one trigger condition includes, at the second layer of the of the communication protocol, receiving a cancel request message and detecting the at least one delayed message, the at least one delayed message indicative of an invite request message, wherein the invite request message is indicative of the device initiating a voice call and the cancel request message is indicative that the invite request message was blocked by the access barring procedure.

24. The device of claim 21, wherein the at least one trigger condition includes the first layer receiving a rejection notification based on the device attempting to make a call during the access barring procedure while the at least one delayed message is delayed, the at least one delayed message being at least one pending TCP sync request message.

25. A non-transitory computer readable medium comprising code that, when executed, performs a method of providing wireless communications, the method comprising:
detecting, at a user equipment, a loss of connectivity between the user equipment and a communication network, the user equipment having at least a first and second layer of a communication protocol;
sending one or more messages from the first layer to the second layer, the second layer configured to send the one or more messages to communication network, at least one message of the one or more messages being delayed at the second layer based on the loss of connectivity;
identifying, at the first layer, at least one trigger condition;
determining, at the first layer, to abort the sending of a first delayed message of the at least one delayed message to the communication network based on the identified at least one trigger condition;
communicating, by the first layer, to the second layer the determination to abort the sending of the first delayed message; and
aborting the sending of the first delayed message at the second layer.

26. The non-transitory computer readable medium of claim 25, wherein the user equipment includes a plurality of processors, the first layer located on a first processor and the second layer located on a second processor.

27. The non-transitory computer readable medium of claim 25, wherein the loss of connectivity is based on an access barring procedure, the access barring procedure configured to block the user equipment from sending messages to the communication network.

28. The non-transitory computer readable medium of claim 27, wherein identifying at least one trigger condition includes the first layer sending the one or more messages during the access barring procedure, wherein each of the one or more messages is indicative of an attempt to register the user equipment on the communication network.

29. The non-transitory computer readable medium of claim 27, wherein identifying at least one trigger condition includes, at the second layer of the of the communication protocol, receiving a cancel request message and detecting the at least one delayed message, the at least one delayed message indicative of an invite request message, wherein the invite request message is indicative of the user equipment initiating a voice call and the cancel request message is indicative that the invite request message was blocked by the access barring procedure.

30. The non-transitory computer readable medium of claim 27, wherein identifying at least one trigger condition includes the first layer receiving a rejection notification based on the user equipment attempting to make a call during the access barring procedure while the at least one delayed message is delayed, the at least one delayed message being at least one pending TCP sync request message.
